(19) United States
(12) Patent Application Publication
(10) Pub. No.: US 2011/0296062 A1
(43) Pub. Date: Dec. 1, 2011

(54) STORAGE APPARATUS AND METHOD FOR CONTROLLING STORAGE APPARATUS

(76) Inventors: Itaru Isobe, Atsugi (JP); Yoshihito Nakagawa, Ooi (JP); Takashi Ochi, Odawara (JP)

(21) Appl. No.: 12/526,683

(22) PCT Filed: Jun. 23, 2009
(86) PCT No.: PCT/JP2009/002861

§ 371 Date: Aug. 11, 2009

(51) Int. Cl. G06F 13/28

(52) U.S. Cl. 710/22

(57) ABSTRACT

An object is to efficiently and securely process a data I/O request received from an external apparatus by a storage apparatus. A storage apparatus 10 includes a channel board 11, a drive board 13, a cache memory 14, a plurality of processor boards 12 that perform data transfer, and a shared memory 15, and the channel board 11 stores a third destination search 1211 that associates a sequence identifier with a processor identifier, the sequence identifier being information that identifies a sequence which includes a series of data frames delivered to and received from a host apparatus 2 and to which a data frame belongs, the processor identifier being information that identifies a processor 1221 included in the processor board 12. The channel board 11 determines a processor to be a destination for the received data frame by acquiring the processor identifier associated with the sequence identifier acquired from the received data frame, from the third destination search 1211, and transfers the received data frame to the processor 1221 thus determined.

### TECHNICAL FIELD

The present invention relates to a storage apparatus and a method for controlling the storage apparatus, and particularly relates to a technique for efficiently and securely processing a data I/O request that a storage apparatus receives from an external apparatus.

### BACKGROUND ART

For example, PTL 1 has disclosed a storage system including multiple host adapters, multiple disk adapters, a cache memory, a shared memory, and a storage device. In the storage system, the host adapters control data transfer between a host computer and the cache memory, and the disk adapters control data transfer between the cache memory and the storage device. The cache memory temporarily holds data received from the host computer or data read from the storage device. The host adapters and the disk adapters share the shared memory.

### CITATION LIST

### Patent Literature

PTL 1: Japanese Patent Application Laid-open Publication No. 2005-018506

### SUMMARY OF INVENTION

### Technical Problem

In such a storage apparatus having the above-mentioned configuration, appropriate load balancing needs to be performed in order to prevent concentration of I/O process load on a particular processor that forms the host adapter or the disk adapter. When load balancing is to be performed, influence by control for the load balancing on performance or the like of the storage apparatus should be minimized as much as possible.

The present invention has been made in consideration of such a background. An object of the present invention is to provide a storage apparatus and a method for controlling the storage apparatus that allow efficient and secure processing of a data I/O request that the storage apparatus receives from an external apparatus.

### Solution to Problem

In order to achieve the above-mentioned object, one aspect according to the present invention is a storage apparatus including at least one channel hoard for receiving a data frame transmitted from an external apparatus, the data frame including a data I/O request, at least one drive board for writing data into a storage device and reading data from the storage device, the storage device being formed of a plurality of storage drives, a cache memory for storing any of write data to be written into the storage device and read data having read from the storage device, a plurality of processor boards each for performing data transfer between at least two of the channel board, the drive board, and the cache memory, and a shared memory accessible by the processor boards, wherein the channel board stores a third destination search table that associates a sequence identifier with a processor identifier, the sequence identifier being information that identifies a sequence of a series of data frames delivered to and received from the external apparatus and to which the data frame belongs, the processor identifier being information that identifies a processor included in the processor board, and determines the processor to be a destination for the received data frame, by acquiring, from the third destination search table, the processor identifier associated with the sequence identifier acquired from the received data frame, the channel board stores a first destination search table that associates an identifier of a communication port included in the channel board, an identifier of the external apparatus, an identifier of a logical volume provided by the storage device, and the processor identifier with each other, when the sequence identifier cannot be acquired from the received data frame, the channel board determines the processor to be the destination for the data frame by acquiring, from the first destination search table, the processor identifier associated with a combination of the identifier of the communication port at which the data frame has arrived, the identifier of the external apparatus included in the data frame, and the identifier of the logical volume included in the data frame, the channel board stores a second destination search table that associates the identifier of the logical volume provided by the storage device with the processor identifier, when the sequence identifier cannot be acquired from the received data frame, the channel board determines the processor to be the destination for the data frame by acquiring, from the second destination search table, the processor identifier associated with the identifier of the logical volume included in the data frame, the channel board stores a fourth destination search table that associates the identifier of the communication port with the processor identifier, when the processor to be the destination for the data frame cannot be determined using any of the first to the third destination search tables, the channel board determines the processor to be the destination for the received data frame by acquiring, from the fourth destination search table, the processor identifier associated with the identifier of the communication port at which the data frame has arrived, and transfers the received data frame to the processor thus determined, and the processor that has received the data frame performs processing with regard to the data frame.

According to the present invention, the third destination search table is searched for the processor identifier associated with the sequence identifier acquired from the data frame, and the processor to be the destination for the data frame is thereby determined. Thus, when the sequence identifier can be acquired from the data frame, the destination can be determined by using only the sequence identifier as a key. Accordingly, the destination processor can be determined at a higher speed and a lower load. Appropriate setting of the third destination search table can attain appropriate load balancing among the processors.

Moreover, according to the present invention, even when the sequence identifier cannot be acquired from the data frame, the destination processor can be determined by using the identifier of the communication port at which the data frame has arrived, the identifier of the external apparatus included in the data frame, and the identifier of the logical volume included in the data frame, as a key, to search the first destination search table. Accordingly, even when the sequence identifier cannot be acquired from the data frame, load balancing among the processors can be attained. Appropriate setting of the first destination search table can accomplish appropriate load balancing among the processors. This scheme can be applied, for example, to a case where the data frame is a data frame including a host command (SCSI command).

Moreover, according to the present invention, even when the sequence identifier cannot be acquired from the data frame, the destination processor can be determined by using the identifier of the logical volume included in the data frame as a key to search the second destination search table. Accordingly, even when the sequence identifier cannot be acquired from the data frame, load balancing among the processors can be attained. Moreover, since the destination processor can be determined by using only the identifier of the logical volume as a key, the destination processor can be determined at a higher speed and a lower load. In addition, appropriate setting of the second destination search table can accomplish appropriate load balancing among the processors. This scheme can be applied, for example, to a case where the data frame is a data frame including a vendor-unique command.

Moreover, according to the present invention, even when the sequence identifier cannot be acquired from the data frame with any of the first to the third destination search tables, the processor can be determined by using the identifier of the communication port, at which the data frame has arrived, as a key, to search the fourth destination search table. Accordingly, even when the destination processor cannot be determined using any of the first to third destination search tables, load balancing among the processors can be attained. Moreover, since the destination processor can be determined by using only the identifier of the communication port as a key, the destination processor can be determined at a higher speed and a lower load. In addition, appropriate setting of the fourth destination search table can accomplish appropriate load balancing among the processors.

The channel board includes: a frame processing chip that registers the data frame received from the external apparatus in a queue; and a frame transfer chip that reads the data frame from the queue, determines a processor to be the destination for the read data frame, and transfers the data frame to the processor thus determined.

Moreover, the frame processing chip registers the data frame including the sequence identifier in the queue, the data frame being for notifying the processor of a message indicating that the external apparatus has been responded with regard to the processing performed according to the data I/O request, and the frame transfer chip determines the processor to be the destination for the data frame by acquiring, from the third destination search table, the processor identifier associated with the sequence identifier acquired from the data frame, and transfers the received data frame to the processor thus determined to be the destination.

According to this, also when the processor is notified of the message indicating that the external apparatus has been responded with regard to the processing performed according to the data I/O request, the data frame in which the sequence identifier of a frame being currently processed is set is registered in the queue, and the destination of the registered data frame is determined by acquiring the processor identifier associated with the sequence identifier from the third destination search table. Thus, according to the present invention, even when internal communication is performed between the frame processing chip and the processor, the destination processor can be appropriately selected, and more secure load balancing among the processors can be attained.

The data frame is, for example, an FC frame of the Fibre Channel protocol. The sequence is an exchange sequence, and the sequence identifier is, for example, an exchange number set in an RX_ID of the FC frame.

Moreover, the processor identifier is an identifier that identifies a processor set formed of a plurality of the processors.

In addition, other tasks and the solutions disclosed herein will be clarified with description of embodiments of the invention and the drawings.

### Advantageous Effects of Invention

According to the present invention, a data I/O request that a storage apparatus receives from an external apparatus can be processed efficiently and securely.

### BRIEF DESCRIPTION OF DRAWINGS

FIG. 1 is a diagram showing a configuration of a storage system 1.

FIG. 2A is a diagram showing a hardware configuration of a channel board 11.

FIG. 2B is a diagram showing a hardware configuration of a processor board 12.

FIG. 2C is a diagram showing a hardware configuration of a drive board 13.

FIG. 3 shows an example of hardware (computer 30) to be used as a maintenance apparatus 18 or a management apparatus 3.

FIG. 4 shows a principal function of the management apparatus 3.

FIG. 5 shows principal functions of and principal data in a storage apparatus 10.

FIG. 6 is a flowchart illustrating data write processing S600.

FIG. 7 is a flowchart illustrating data read processing S700.

FIG. 8 is a diagram illustrating a configuration concerning processing of a frame in the channel board 11.

FIG. 9 is a diagram illustrating a configuration concerning processing of a frame in the processor board 12.

FIG. 10A shows an example of a configuration of a microprocessor 1221, a processor set 1230, an L2, and a PM 123.

FIG. 10B shows an example of a configuration of the microprocessor 1221, the processor set 1230, the L2, and the PM 123.

FIG. 10C shows an example of a configuration of the microprocessor 1221, the processor set 1230, the L2, and the PM 123.

FIG. 11A shows a schematic configuration of a frame including a data write request.

FIG. 11B shows a schematic configuration of a frame including a data read request.

FIG. 12 is a diagram showing a configuration of a destination search table 521.

FIG. 13A shows an example of a host command search table 1211.

FIG. 13B shows an example of a vendor-unique command search table 1212.

FIG. 13C shows an example of an exchange number mapping table 1213.

FIG. 13D shows an example of a port number mapping table 1214.

FIG. 14 shows a detailed field configuration of a frame header 1400.

FIG. 15A shows a field configuration of an IMQ entry 1511.

FIG. 15B shows a field configuration of an IMQ entry 1512.

FIG. 15C shows a field configuration of an IMQ entry 1513.

FIG. 16 shows a field configuration of an SFQ entry 1600.

FIG. 17 is a flowchart illustrating frame transfer processing S1700.

FIG. 18 is a flowchart illustrating destination determination processing S1723.

FIG. 19 is a flowchart illustrating destination determination processing S1821 according to a first method.

FIG. 20 is a flowchart illustrating destination determination processing S1822 according to a second method.

FIG. 21 is a flowchart illustrating a destination determination processing S1823 according to a third method.

FIG. 22 is a diagram illustrating processing performed in the storage apparatus 10 when a frame including a data read request is received.

FIG. 23 is a diagram illustrating processing performed in the storage apparatus 10 when a frame including a data read request is received (in a case where a data length of the read data is long).

FIG. 24 is a diagram illustrating processing performed in the storage apparatus 10 when a frame including a data write request is received.

### DESCRIPTION OF EMBODIMENTS

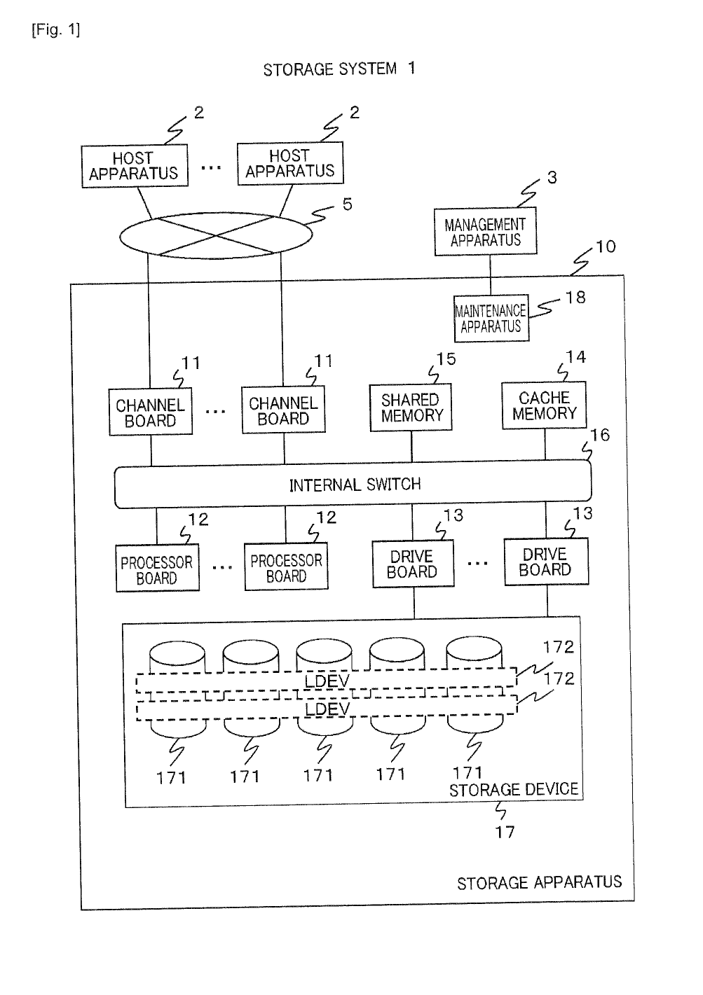

Hereinafter, an embodiment will be described. FIG. 1 shows a configuration of a storage system 1, which will be described as one embodiment. As shown in FIG. 1, the storage system 1 is formed including host apparatuses 2 (external apparatuses), a storage apparatus 10 that communicates with the host apparatuses 2 through a communication network 5, and a management apparatus 3 communicatively coupled to the storage apparatus 10 through a LAN (Local Area Network) or the like.

The communication network 5 is, for example, a LAN, a SAN (Storage Area Network), the Internet, a public communication network, or the like. Communication between the host apparatus 2 and the storage apparatus 10 is performed in accordance with a protocol such as TCP/IP, iSCSI (internet Small Computer System Interface), Fibre Channel protocol, FICON (Fibre Connection) (registered trademark), ESCON (Enterprise System Connection) (registered trademark), ACONARC (Advanced Connection Architecture) (registered trademark), or FIBARC (Fibre Connection Architecture) (registered trademark).

The host apparatus 2 is an information processing apparatus (computer) using a storage area provided by the storage apparatus 10. For example, the host apparatus 2 is formed using hardware such as a personal computer, a mainframe, or on office computer. In order to access the above-mentioned storage area, the host apparatus 2 transmits a data frame including a data I/O request (such as a data write request and a data read request) to the storage apparatus 10 (hereinafter such data frame is simply referred to as a frame).

The storage apparatus 10 includes one or more channel boards 11, one or more processor boards 12 (micro processor), one or more drive boards 13, a cache memory 14, a shared memory 15, an internal switch 16, a storage device 17, and a maintenance apparatus 18 (SVP: SerVice Processor). The channel boards 11, the processor boards 12, the drive boards 13, the cache memory 14, and the shared memory 15 are communicatively coupled to one another through the internal switch 16.

The channel board 11 receives the frame transmitted from the host apparatus 2, and transmits a frame including a response indicating that processing having been performed according to a data I/O request included in the received frame (for example, read data, read completion report, or write completion report) to the host apparatus 2. Note that, in the description below, the frame is a frame of Fibre Channel (FC frame (FC: Fibre Channel)).

In response to the above-mentioned data I/O request included in the frame received by the channel board 11, the processor board 12 performs processing concerning data transfer performed among the channel board 11, the drive board 13, and the cache memory 14. The processor board 12 performs processing such as passing of data (read from or written into the storage device 17) between the channel board 11 and the drive board 13 through the cache memory 14, staging of the data stored in the cache memory 14 (reading of the data from the storage device 17), and destaging of the data (writing of the data into the storage device 17).

The cache memory 14 is formed using a RAM (Random Access Memory) that allows high speed access. Data to be written into the storage device 17 (hereinafter referred to as write data) and data having been read from the storage device 17 (hereinafter referred to as read data) are stored in the cache memory 14. Various kinds of information used for control of the storage apparatus 10 are stored in the shared memory 15.

The drive board 13 communicates with the storage device 17 when reading data from the storage device 17 or writing data into the storage device 17. The internal switch 16 is formed, for example, using a high-speed cross bar switch. Communication performed through the internal switch 16 is performed in accordance with a protocol such as Fibre Channel, iSCSI, or TCP/IP.

The storage device 17 is formed including multiple storage drives 171. The storage drive 171 is, for example, a hard disk drive of a type such as SAS (Serial Attached SCSI), SATA (Serial ATA), FC (Fibre Channel), PATA (Parallel ATA), or SCSI, or a semiconductor memory device (SSD).

The storage device 17 provides a storage area in units of logical storage areas provided by controlling the storage drives 171 by a control method such as RAID (Redundant Arrays of Inexpensive (or Independent) Disks). Each of the logical storage areas is a logical device (LDEV 172 (LDEV: Logical Device)) formed using, for example, a RAID group (parity group (Parity Group)). Moreover, the storage apparatus 10 provides the host apparatus 2 with a logical storage area (hereinafter referred to as an LU (Logical Unit)) formed using the LDEV 172. The storage apparatus 10 manages a correspondence between the LU and the LDEV 172, and performs identification of the LDEV 172 associated with the LU or identification of the LU associated with the LDEV 172, on the basis of this correspondence.

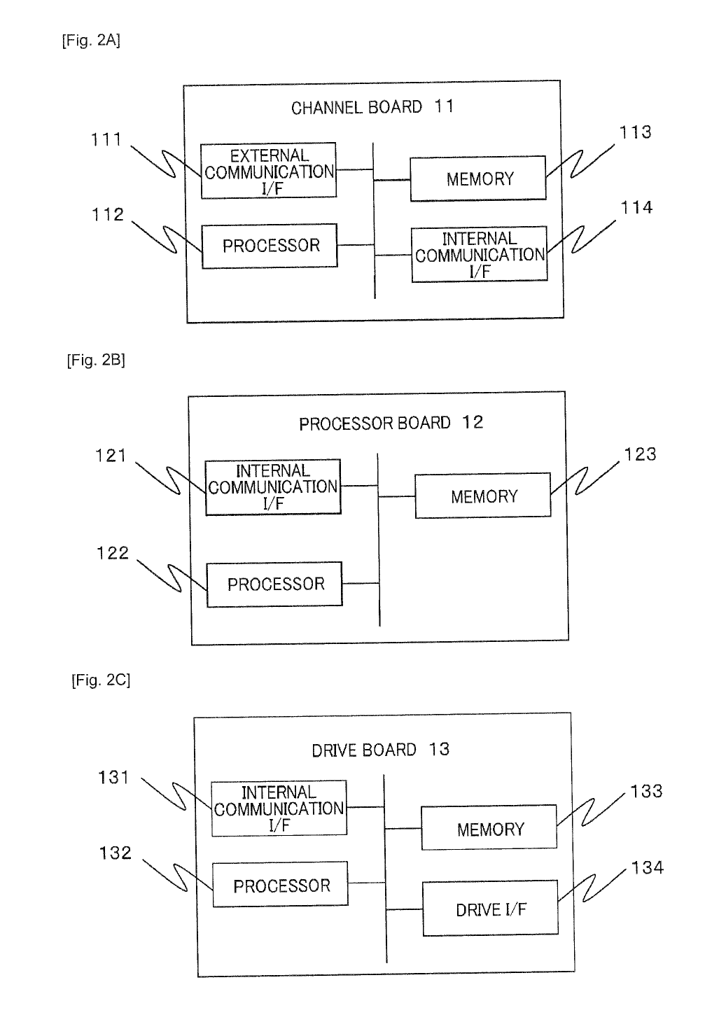

FIG. 2A shows a hardware configuration of each channel board 11. The channel board 11 includes an external communication interface having a port (communication port) for communicating with the host apparatus 2 (hereinafter, written as an external communication I/F 111), a processor 112 (including a frame processing chip and a frame transfer chip, which will be described later), a memory 113, and an internal communication interface having a port (communication port) for communicating with the processor board 12 (hereinafter, written as an internal communication I/F 114).

The external I/F 111 is formed using a NIC (Network Interface Card), an HBA (Host Bus Adaptor), or the like. The processor 112 is formed using a CPU (Central Processing Unit), an MPU (Micro Processing Unit), or the like. The memory 113 is a RAM (Random Access Memory) or a ROM (Read Only Memory). The internal communication I/F 114 communicates with the processor board 12, the drive board 13, the cache memory 14, and the shared memory 15 through the internal switch 16.

FIG. 2B shows a hardware configuration of the processor board 12. The processor board 12 includes an internal communication interface (hereinafter, written as an internal communication I/F 121), a processor 122, and a memory 123 (local memory) accessible by the processor 122 with higher access performance (higher speed accessibility) than the shared memory 15.

The internal communication I/F 121 communicates with the channel board 11, the drive board 13, the cache memory 14, and the shared memory 15 through the internal switch 16. The processor 122 is formed using a CPU, an MPU, a DMA (Direct Memory Access), or the like. The memory 123 is a RAM or a ROM. The processor 122 can access both of the memory 123 and the shared memory 15. From a viewpoint of the processor 122, the memory 123 has an access speed higher than that of the shared memory 15 (the memory 123 has access performance higher than that of the shared memory 15), and the memory 123 has access cost lower than that of the shared memory 15.

FIG. 2C shows a hardware configuration of the drive board 13. The drive board 13 includes an internal communication interface (hereinafter, written as an internal communication I/F 131), a processor 132, a memory 133, and a drive interface (hereinafter, written as a drive I/F 134). The internal communication I/F 131 communicates with the channel board 11, the processor board 12, the cache memory 14, and the shared memory 15 through the internal switch 16. The processor 132 is formed using a CPU, an MPU, or the like. The memory 133 is, for example, a RAM or a ROM. The drive I/F 134 communicates with the storage device 17.

The maintenance apparatus 18 shown in FIG. 1 is an apparatus for controlling the components in the storage apparatus 10 and monitoring their conditions, and is a computer including a CPU and a memory. Through communication means such as the internal switch 16 or a LAN, the maintenance apparatus 18 communicates with the components of the storage apparatus 10 such as the channel board 11, the processor board 12, the drive board 13, the cache memory 14, the shared memory 15, and the internal switch 16. The maintenance apparatus 18 acquires usage information and the like from the components of the storage apparatus 10 as needed, and provides the management apparatus 3 with the information thus acquired. For the components, the maintenance apparatus 18 performs various setting, control, maintenance (introduction and update of software), and the like in accordance with control information transmitted from the management apparatus 3.

The management apparatus 3 is communicatively coupled to the maintenance apparatus 18 through a LAN or the like. The management apparatus 3 includes a user interface employing a GUI (Graphical User Interface), a CLI (Command Line Interface), or the like to control or monitor the storage apparatus 10.

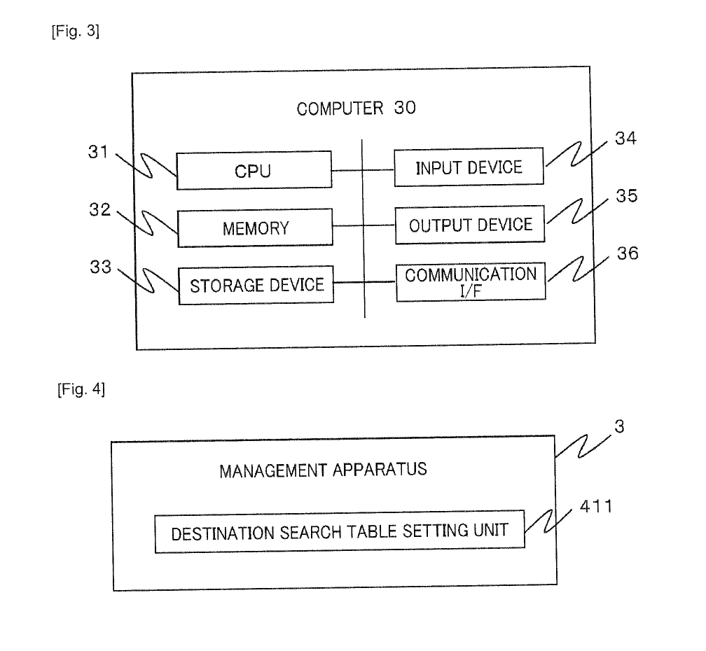

FIG. 3 shows an example of hardware (computer 30) to be used as the maintenance apparatus 18 or the management apparatus 3. As shown in FIG. 3, the computer 30 includes a CPU 31, a volatile or nonvolatile memory 32 (a RAM or a ROM), a storage device 33 (for example, a hard disk drive or a semiconductor memory device (SSD)), input devices 34 such as a keyboard and a mouse, output devices 35 such as a liquid crystal display monitor and a printer, and a communication interface such as a NIC or an HBA (referred to as a communication I/F 36). The management apparatus 3 is, for example, a personal computer or an office computer. The management apparatus 3 may be integrated with the storage apparatus 10 by, for example, being accommodated in the same housing as that of the storage apparatus 10.

FIG. 4 shows a principal function of the management apparatus 3. As shown in FIG. 4, the management apparatus 3 includes a destination search table setting unit 411 that provides a user interface for setting a destination search table 521, which will be described later. The function of the management apparatus 3 is implemented by the hardware of the management apparatus 3, or by the CPU 31 of the management apparatus 3 reading and executing a program stored in the memory 32 of the management apparatus 3.

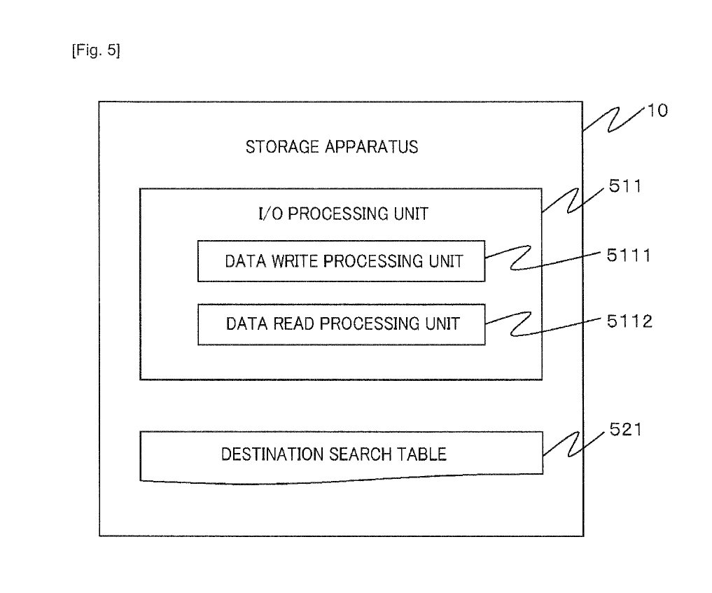

FIG. 5 shows principal functions of the storage apparatus 10 and principal data managed in the storage apparatus 10. As shown in FIG. 5, the storage apparatus 10 includes an I/O processing unit 511 as a function. The I/O processing unit 511 has a data write processing unit 5111 that performs processing concerning writing of data into the storage device 17, and a data read processing unit 5112 that performs processing concerning reading of data from the storage device 17.

The functions of the I/O processing unit 511 is implemented by hardware of the channel board 11, the processor board 12, and the drive board 13 of the storage apparatus 10, or implemented by the processors 112, 122, and 132 reading and executing a program stored in the memories 113, 123, and 133 or the shared memory 15. Moreover, the storage apparatus 10 stores a destination search table 521 in the memory 113 of the channel board 11. Detailed description of the destination search table 521 will be given later.

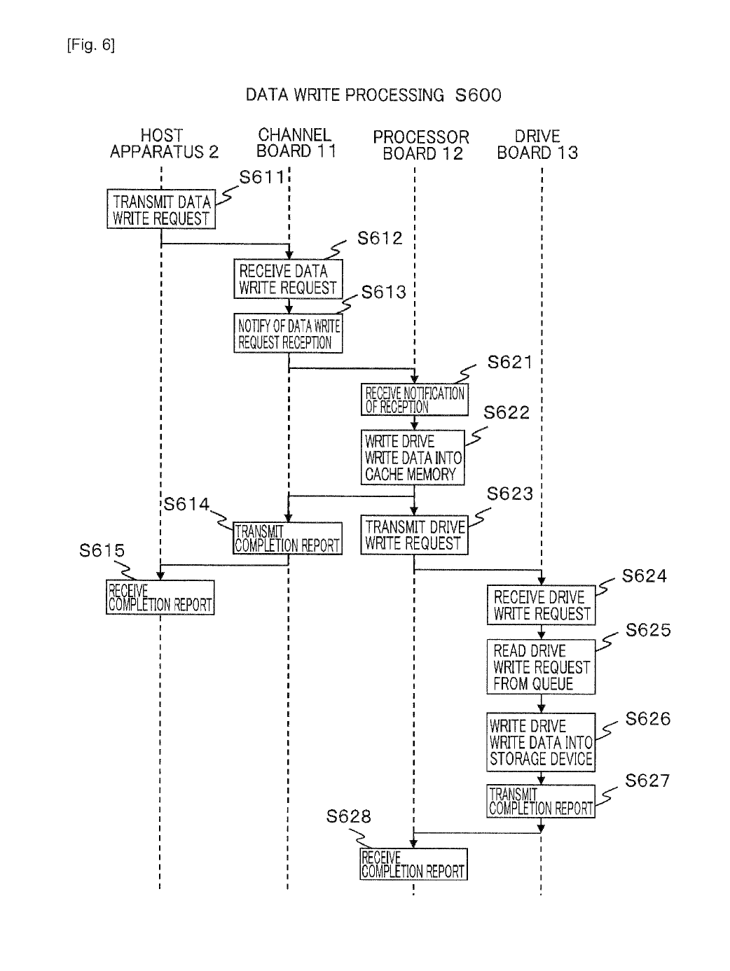

FIG. 6 is a flowchart illustrating processing performed by the data write processing unit 5111 of the I/O processing unit 511 when the storage apparatus 10 receives a frame including a data write request from the host apparatus 2 (hereinafter referred to as data write processing S600). With reference to FIG. 6, the data write processing S600 will be described below. Note that in the descriptions below, a character “S” given before a reference numeral means a step.

A frame transmitted from the host apparatus 2 is received by the channel board 11 of the storage apparatus 10 (S611, S612). Upon reception of the frame, the channel board 11 notifies the processor board 12 and the drive board 13 of the reception of the frame (S613).

Upon reception of the above-mentioned notification from the channel board 11 (S621), the processor board 12 generates a drive write request on the basis of the data write request in the frame, stores the drive write request in the cache memory 14, and transmits the generated drive write request to the drive board 13 (S622, S623). The channel board 11 transmits a completion report to the host apparatus 2 (S614), and the host apparatus 2 receives the transmitted completion report (S615).

Upon reception of the drive write request, the drive board 13 registers the drive write request in a write processing waiting queue (S624). The drive board 13 reads the drive write request from the write processing waiting queue as needed (S625). Then, the drive board 13 reads drive write data specified by the read drive write request from the cache memory 14, and writes the read drive write data into the storage drive 171 (S626).

Next, the drive board 13 notifies the processor board 12 of a report (completion report) that writing of the drive write data according to the drive write request has been completed (S627). The processor board 12 receives the transmitted completion report (S628).

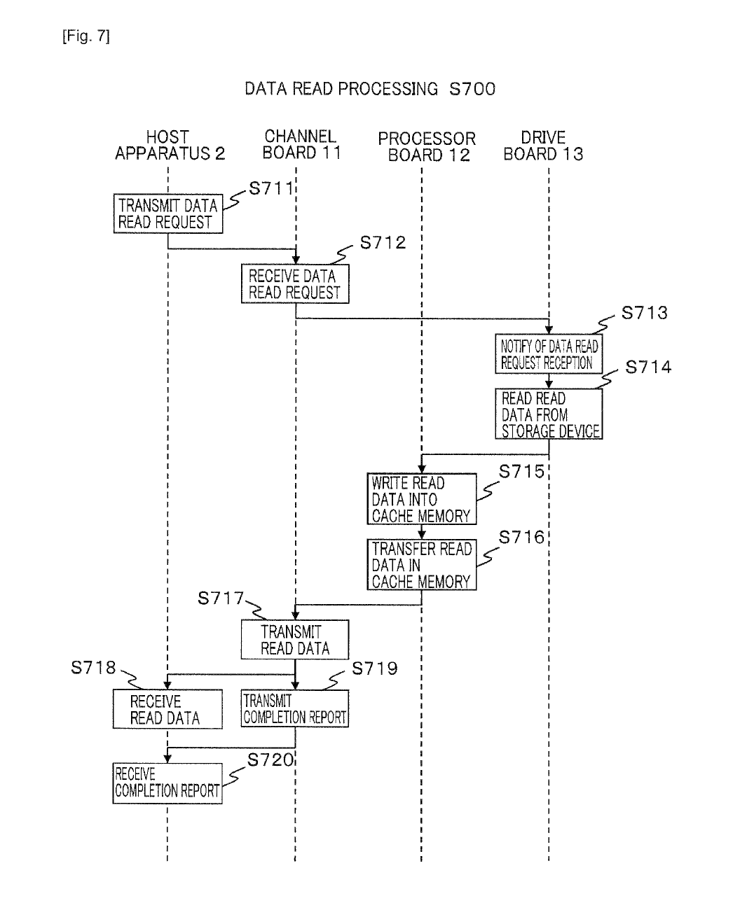

FIG. 7 is a flowchart illustrating I/O processing performed by the data read processing unit 5112 of the I/O processing unit 511 in the storage apparatus 10 when the storage apparatus 10 receives a frame including a data read request from the host apparatus 2 (hereinafter referred to as a data read processing S700). With reference to FIG. 7, the data read processing S700 will be described below.

A frame transmitted from the host apparatus 2 is received by the channel board 11 of the storage apparatus 10 (S711, S712). Upon reception of the frame from the host apparatus 2, the channel board 11 notifies the processor board 12 and drive board 13 of the reception of the frame (S713).

Upon reception of the above-mentioned notification from the channel board 11, the drive board 13 reads data specified by the data read request included in the frame from the storage device 17 (storage drive 171) (the data is specified by, for example, an LBA (Logical Block Address)) (S714). When the read data exists in the cache memory 14 (in a case of a cache hit), processing of reading from the storage device 17 (S714) is omitted. The processor board 12 writes the data read by the drive board 13 into the cache memory 14 (S715). The processor board 12 transfers the data written into the cache memory 14 to the communication I/F as needed (S716).

The channel board 11 sequentially transmits the read data transmitted from the processor board 12 to the host apparatus 2 (S717, S718). When transmission of the read data is completed, the channel board 11 transmits a completion report to the host apparatus 2 (S719). The host apparatus 2 receives the transmitted completion report (S720).

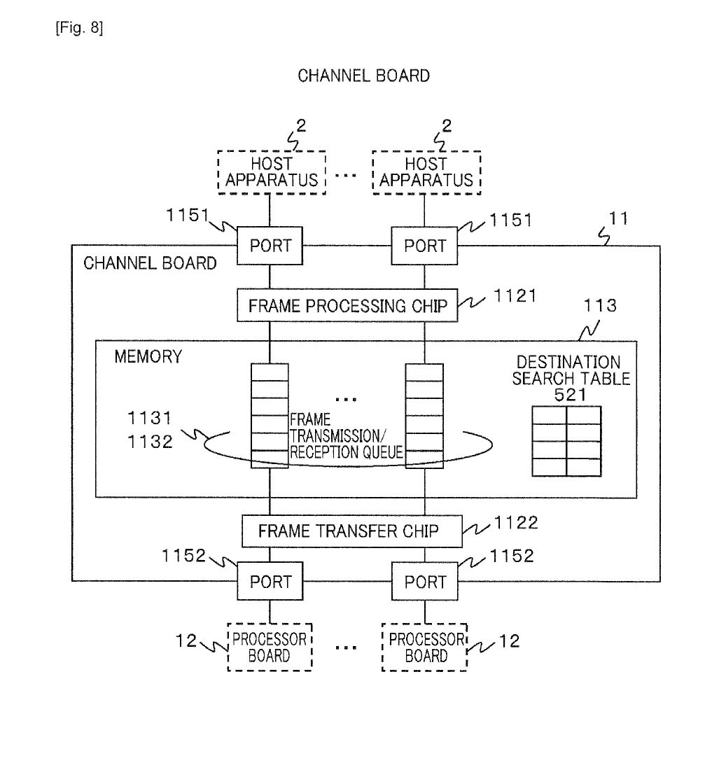

FIG. 8 shows a configuration concerning frame processing in the channel board 11. As shown in FIG. 8, the channel board 11 includes a port 1151 that receives a frame transmitted from the host apparatus 2, a frame processing chip 1121 (protocol processing chip) and a frame transfer chip 1122 (LRP (Local Router Processor)), which have been described above as components of the processor 112, the above-mentioned memory 113, and a port 1152 used for communication with the processor board 12.

As shown in FIG. 8, the memory 113 of the channel board 11 is provided with frame transmission/reception queues (a frame transmission queue 1131 and a frame reception queue 1132) for delivery and reception (transmission and reception) of the frame between the frame processing chip 1121 and the frame transfer chip 1122. The frame transmission/reception queues 1131 and 1132 are provided for each port 1151 in the channel board. With respect to each frame which arrives at the frame reception queue 1132, the channel board 11 manages information showing at which port 1151 the frame has arrived. The destination search table 521 shown in FIG. 5 is stored in the memory 113.

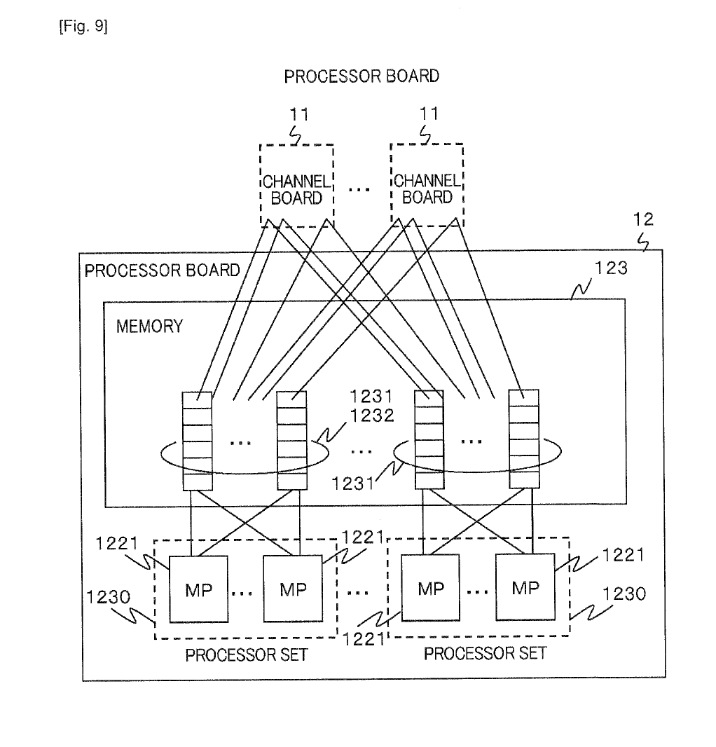

FIG. 9 shows a configuration concerning frame processing performed by the processor board 12. As shown in FIG. 9, the processor board 12 includes multiple microprocessors 1221 (written as MP in FIG. 9), which are components of the processor 122, and the memory 123. Each microprocessor 1221 is, for example, a core processor in a multi-core processor.

The memory 123 of the processor board 12 is provided with frame transmission/reception queues (a frame transmission queue 1231 and a frame reception queue 1232) used when a frame is delivered and received (transmitted and received) between the channel board 11 and the microprocessor 1221. The frame transmission/reception queues 1231 and 1232 are provided for each port 1152 in the channel board.

As shown in FIG. 9, each microprocessor 1221 belongs to either of one or more processor sets 1230 that are set as groups each having the microprocessors 1221 that share the same frame transmission/reception queues 1231 and 1232. The processor set 1230 is set in accordance with increase in the number of cores in a CPU, change of a cache structure in the CPU, or the like.

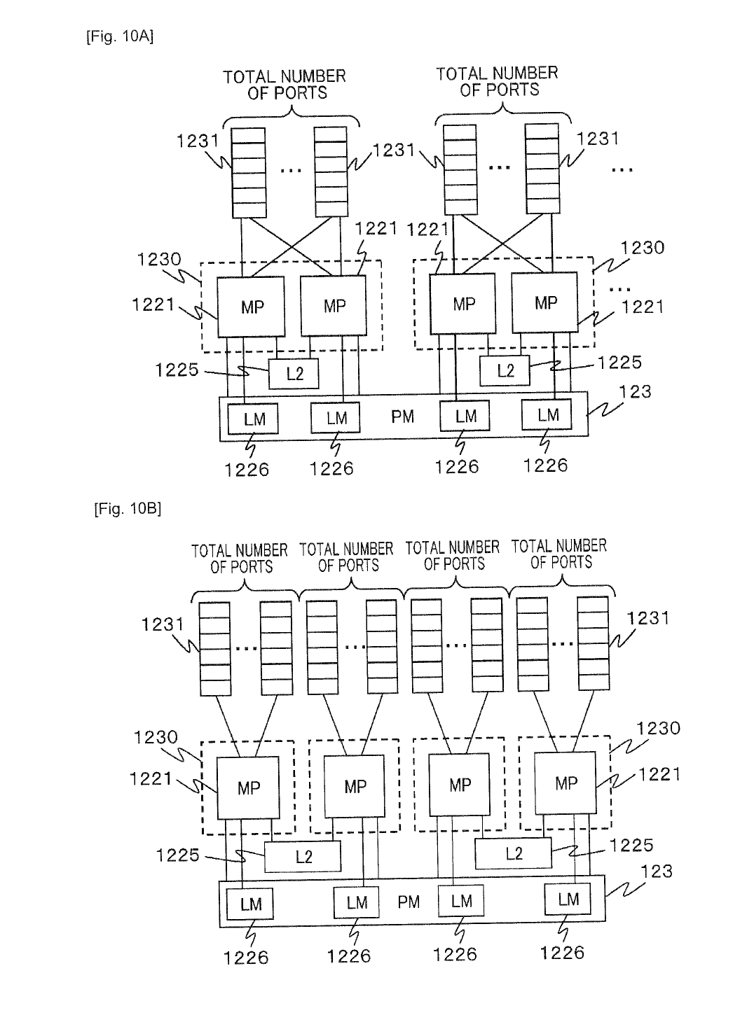

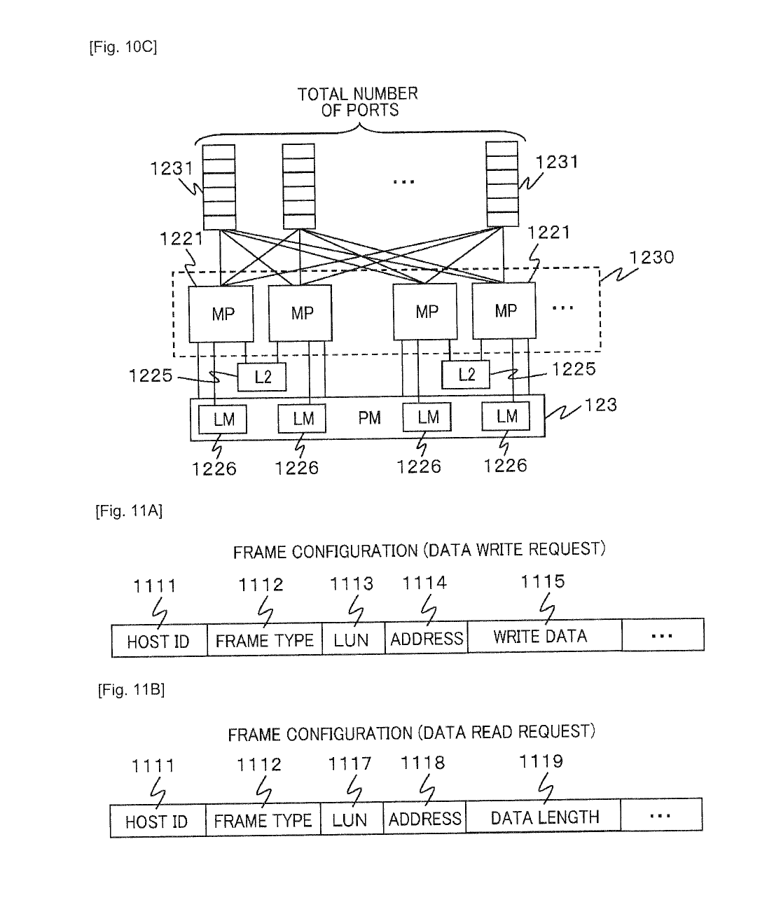

FIGS. 10A to 10C each show an example of a configuration of the microprocessor 1221, the processor set 1230, an L2, and the PM 123. The L2 (1225) in FIGS. 10A to 10C is an internal memory (L2 cache memory) of a CPU, and the PM 123 corresponds to the memory 123 (local memory) mentioned above.

In the form shown in FIG. 10A, two microprocessors 1221 belong to each processor set 1230. Data delivery and data reception between the microprocessors 1221 that belong to the same processor set 1230 are performed through the L2 (1225). In contrast, data delivery and data reception between the microprocessors 1221 that belong to different processor sets 1230 are performed through the PM 123. Each of the processor sets 1230 is associated with the frame transmission/reception queues 1231 and 1232 of all the ports 1152 of all the channel boards 11 within the storage apparatus 10.

Only a particular microprocessor 1221 can access the PM 123 in which storage areas (hereinafter referred to as LMs 1226) requiring no exclusive control are reserved. Each microprocessor 1221 can use the LM 1226 reserved therefor. This configuration allows load balancing between the microprocessors 1221 that belong to the same processor set 1230. The configuration also allows high-speed data delivery and data reception through the L2 (1225) between the microprocessors 1221 that belong to the same processor set 1230.

In the case of FIG. 10B, one microprocessor 1221 belongs to each processor set 1230. Data delivery and data reception between the microprocessors 1221 that belong to different processor sets 1230 are performed through the L2 (1225) or through the PM 123. In this form, the respective processor sets 1230 are associated with the frame transmission/reception queues 1231 and 1232 of all the ports 1152 of all the channel boards 11 within the storage apparatus 10. The LMs 1226 are reserved within the PM 123 for the respective microprocessors 1221, and each microprocessor 1221 can use the PM 123 reserved therefor.

In the case of FIG. 10C, all the microprocessors 1221 belong to one processor set 1230, and data delivery and data reception between the microprocessors 1221 are performed through the L2 (1225) or through the PM 123. In this form, the processor set 1230 is associated with the frame transmission/reception queues 1231 and 1232 of all the ports 1152 of all the channel boards 11 within the storage apparatus 10. The LMs 1226 are reserved within the PM 123 for the respective microprocessor 1221, and each microprocessor 1221 can use the PM 123 reserved therefor.

FIG. 11A shows a schematic configuration of a frame including a data write request.

This frame includes information such as an LUN 1113, an address 1114, write data 1115 in addition to a host ID 1111 and a frame type 1112. An LUN (Logical Unit Number), which is information that identifies an LU of a writing destination, is set i the LUN 1113. An address of a writing destination in the writing destination LU (for example, an LBA) is set in the address 1114. Write data is set in the write data 1115.

FIG. 11B shows a schematic configuration of a frame including a data read request. As shown in FIG. 11B, this frame includes information such as an LUN 1117, an address 1118, and a data length 1119 in addition to a host ID 1111 and a frame type 1112. An LUN, which is information that identifies an LU of a reading destination, is set in the LUN 111. An address of the reading destination in the reading destination (read destination) LU (for example, an LBA) is set in the address 1118. A data length of the read data is set in the data length 1119.

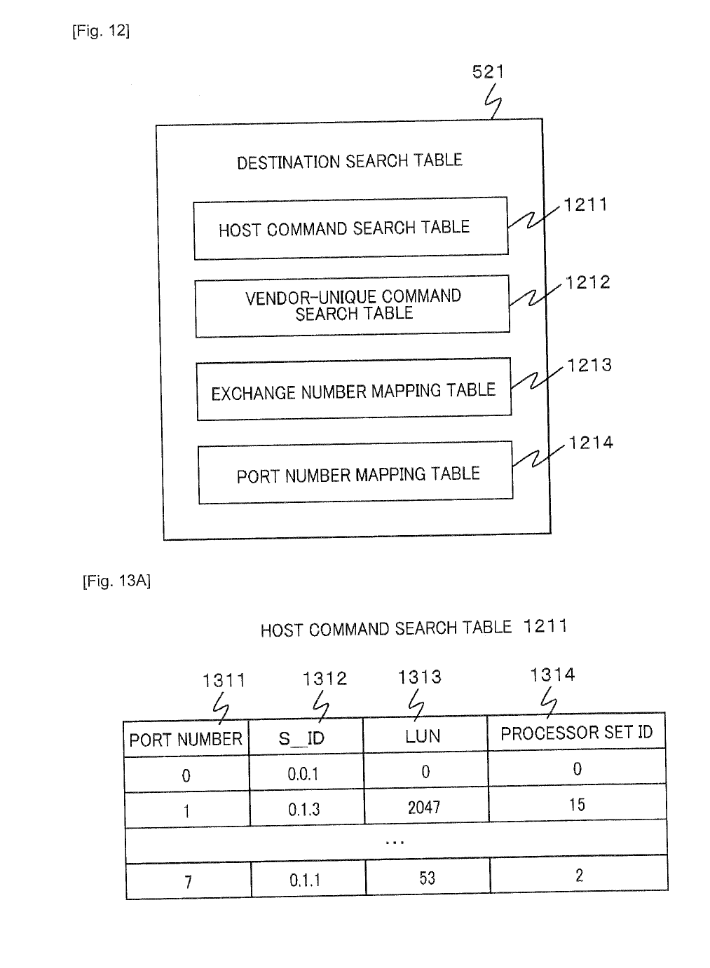

Next, the destination search table 521 mentioned above will be described. FIG. 12 shows a configuration of the destination search table 521. As shown in FIG. 12, the destination search table 521 is formed of the following tables: a host command search table 1211 (first destination search table), a vendor-unique command search table 1212 (second destination search table), an exchange number mapping table 1213 (third destination search table), and a port number mapping table 1214 (fourth destination search table). A user can operate the management apparatus 3 to perform settings of the destination search table 521 stored in the channel board 11.

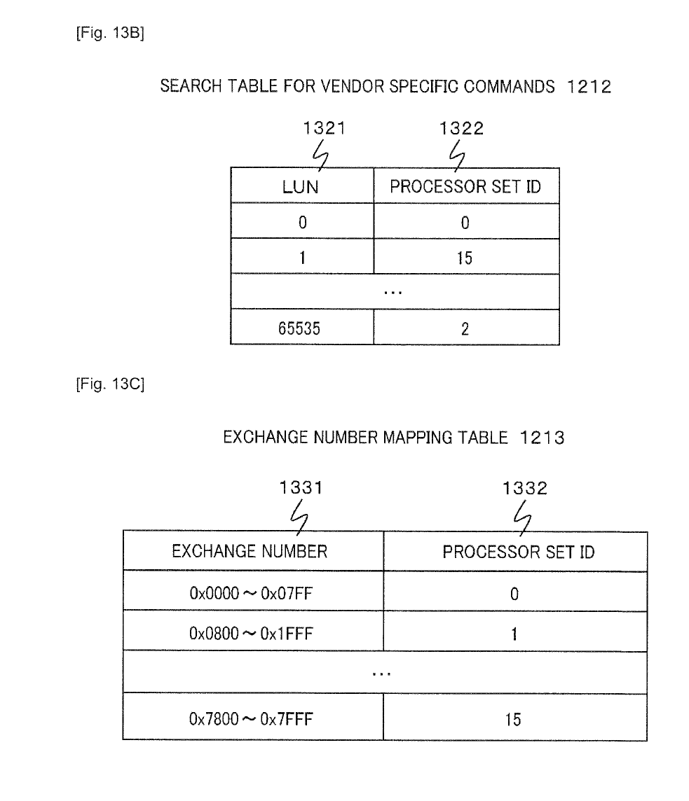

FIG. 13A shows the host command search table 1211. As shown in FIG. 13A, the host command search table 1211 is formed of multiple records each having items including a port number 1311, an S_ID 1312, an LUN 1313, and a processor set ID 1314. What is set in the port number 1311 is an identifier of the port 1151 in the channel board 11 at which the frame transmitted from the host apparatus 2 has arrived. What is set in the S_ID 1312 is information that identifies a source host apparatus 2 having transmitted the frame. The LUN is set in the LUN 1313. What is set in the processor set ID 1314 is an identifier of a frame destination processor set 1230.

FIG. 13B shows the vendor-unique command search table 1212. As shown in FIG. 13B, the vendor-unique command search table 1212 is formed of multiple records each having items including an LUN 1321 in which the LUN is set, and a processor set ID 1322 in which the identifier of the frame destination processor set 1230 is set.

FIG. 13C shows the exchange number mapping table 1213. As shown in FIG. 13C, the exchange number mapping table 1213 is formed of multiple records each having items including an exchange number 1331 in which an exchange number (which is a value set in an RX_ID of a frame header in an FC frame) is set, and a processor set ID 1332 in which the identifier of the frame destination processor set 1230 is set.

FIG. 13D shows the port number mapping table 1214. As shown in FIG. 13D, the port number mapping table 1214 is formed of multiple records each having items including a port number 1341 in which the identifier of the port 1151 of the channel board 11 at which the frame transmitted from the host apparatus 2 has arrived is set, and a processor set ID 1342 in which the identifier of the frame destination processor set 1230 is set.

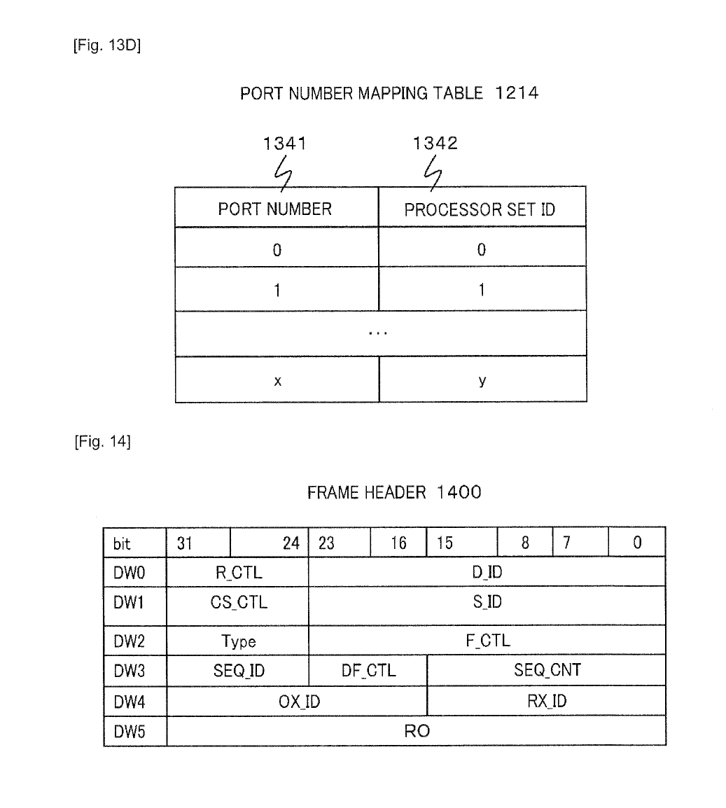

FIG. 14 shows a detailed field configuration of a frame header 1400 of the frame (FC frame) that the frame processing chip 1121 receives from the host apparatus 2. As shown in FIG. 14, the frame header 1400 has fields, such as “R_CTL”, “D_ID”, “CS_CTL”, “S_ID”, “Type”, “F_CTL”, “SEQ_ID”, “DF_CTL”, “SEQ_CNT”, “OX_ID”, “RX_ID” and “RO”.

What is set in the “R_CTL” (Routine Control) is a type of the frame (such as a link frame, a link data frame, or a device data frame) and the like. What is set in the “D_ID” (Destination ID) is information (identifier) that identifies a target device of the frame (for example, the port ID of a target port 1151). What is set in the “CS_CTL” (Class Specific Control) is information that specifies the control class of the FC frame.

What is set in the “S_ID” (Source ID) is an identifier of a transmitting device (the identifier of the host apparatus 2 that has transmitted the frame). What is set in the “Type” (Data Structure Type) is information showing which type of data has been transmitted in relation to the “R_CTL” (for example, “SCSI-FCP”). What is set in the “F_CTL” (Frame Control) is information showing an attribute of an exchange.

What is set in the “SEQ_ID” (Sequence ID) is information (identifier) that identifies multiple types of processing included in the exchange. This information is set for every combination of the “D_ID” and the “S_ID.” When an option header is used, a data length of the option header is set in the “DF_CTL” (Data Field Control). What is set in the “SEQ_CNT” (Sequence Count) is information for identifying ordinal position of the frame in an exchange sequence.

What is set in the “OX_ID” (Originator Exchange ID) is an exchange number numbered by the host apparatus 2 when the storage apparatus 10 is a target, or an exchange number numbered by the storage apparatus 10 when the storage apparatus 10 is an initiator. What is set in the “RX_ID” (Responder Exchange ID) is an exchange number numbered by the storage apparatus 10 when the storage apparatus 10 is a target, or an exchange number numbered by the host apparatus 2 when the storage apparatus 10 is an initiator.

In the description below, an exchange number numbered by the host apparatus 2 is set in the “OX_TD”, and an exchange number numbered by the storage apparatus 10 is set in the “RX_ID”. Moreover, “0xFFFF” is set in the “RX_ID” of the frame starting the exchange sequence (frame that initiates a new exchange sequence transmitted from the host apparatus 2 to the storage apparatus 10).

What is set in “RO” (Relative Offset) is an offset value of an address of a data buffer within an initiator.

The frame reception queue 1132 in which information on the frame received from the host apparatus 2 is registered has an IMQ (Inbound Message Queue) and an SFQ (Single Frame Queue). Upon reception of the frame from the host apparatus 2, the frame processing chip 1121 analyzes the received frame, and generates an entry to be registered in the IMQ (hereinafter referred to as an IMQ entry 1500) and an entry to be registered in the SFQ (hereinafter referred to as an SFQ entry 1600) for each received frame. Then, the frame processing chip 1121 registers the generated IMQ entry 1500 in the IMQ and the generated SFQ entry 1600 in the SFQ.

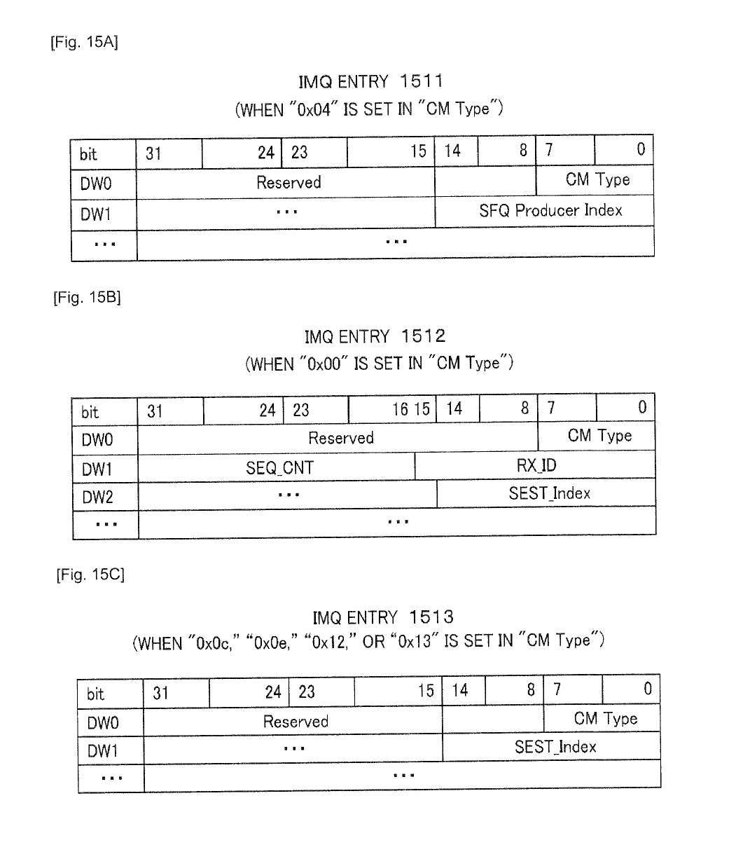

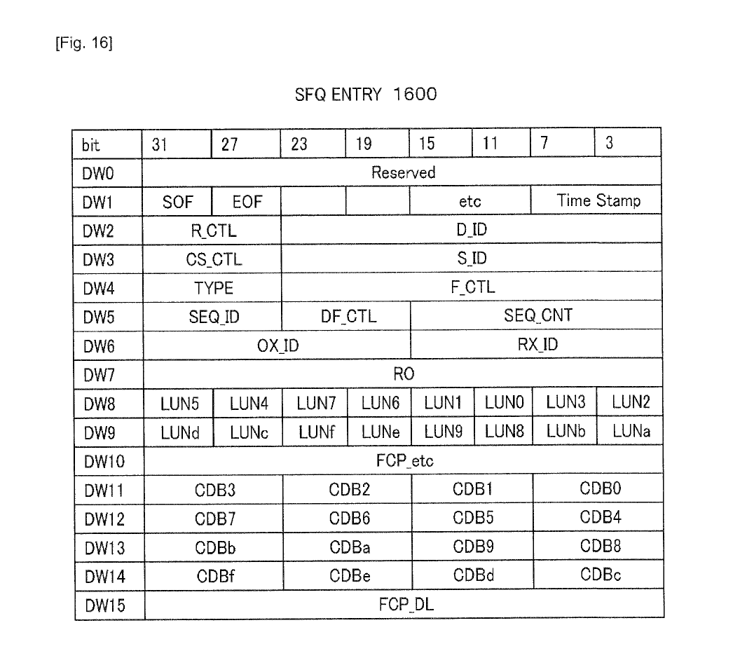

The frame processing chip 1121 determines a field configuration of the IMQ entry 1500 in accordance with the frame received from the host apparatus 2, and generates the IMQ entry 1500 having the field configuration. FIGS. 15A to 15C show variations 1511 to 1513 of the IMQ entry 1500, respectively.

FIG. 15A shows the field configuration of the IMQ entry 1511 registered in the IMQ by the frame processing chip 1121 when the received frame is a frame that initiates a new exchange sequence (a frame having an invalid value (for example, “0xFFFF”) set in the “RX_ID” of the frame header 1400). When the IMQ entry 1511 is generated, “0x04” is set in the “CM Type” (CM: Completion Message). Information that identifies the SFQ entry 1600 associated with the IMQ entry 1511 is set in “SFQ Producer Index”.

FIGS. 15B and 15C show the field configurations of the IMQ entries 1512 and 1513 registered in the IMQ by the frame processing chip 1121 when the received frame is a frame other than a start frame of an exchange sequence (a frame having a valid value (for example, a value except “FFFF” and “NULL”) set in the “RX_ID” of the frame header 1400).

When the IMQ entry 1512 shown in FIG. 15B is generated, “0x00” is set in the “CM Type”. The same value as the exchange number set in the “RX_ID” of the frame header of the frame is set in an “SEST Index” (SEST: SCSI Exchange State Table).

When the IMQ entry 1513 shown in FIG. 15C is generated, either of “0x0c,” “0x0e,” “0x12,” and “0x13” is set in the “CM Type”. The same value as the exchange number set in the “RX_ID” of the frame header of the frame is set in the “SEST Index”.

FIG. 16 shows the field configuration of the SFQ entry 1600. As shown in FIG. 16, the SFQ entry 1600 has fields such as “R_CTL”, “D_ID”, “CS_CTL”, “S_ID”, “TYPE”, “F_CTL”, “SEQ_ID”, “DF_CTL”, “SEQ_CNT”, “OX_ID”, “RX_ID”, and “RO”, in each of which the corresponding content of the frame header 1400 shown in FIG. 14 is set, as well as “LUNx (x=0 to 9, a to f)”, “CDBx (x=0 to 9, a to f)”, FCP_DL, and the like.

The LUN of a target LU of the frame is set in the “LUNX (x=0 to 9, a to f)”. What is set in the “CDBx (x=0 to 9, a to f)” (CS: Command Descriptor Block) are host commands (for example, SCSI commands (Read, Write, Inquiry, Testunit Ready, Reserve, Release)), vendor-unique commands (such as, for example, a command that controls a function of mirroring between the LUs and a command that controls remote duplicate (remote copy) between the storage apparatuses 10), or information, such as an LBA, which accompanies these commands. An upper limit of a data size transferred between the initiator and the target is set in the “FCP_DL” (Data Length).

Frame Transfer Control within a Storage Apparatus

The frame processing chip 1121 registers a frame (IMQ entry 1500 and SFQ entry 1600) in the frame reception queue 1132, and the frame transfer chip 1122 reads and transfers the frame to the processor set 1230 that executes processing for the frame.

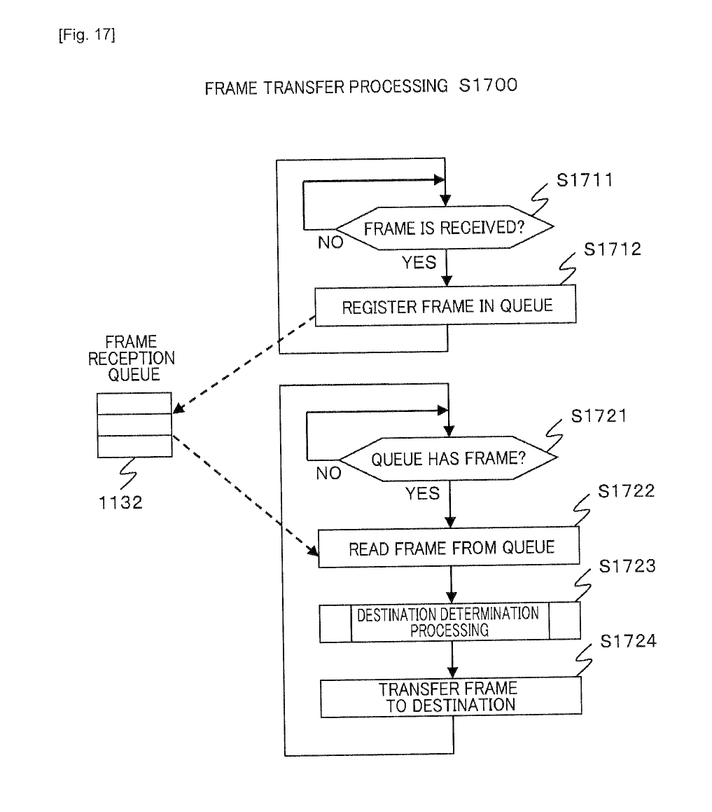

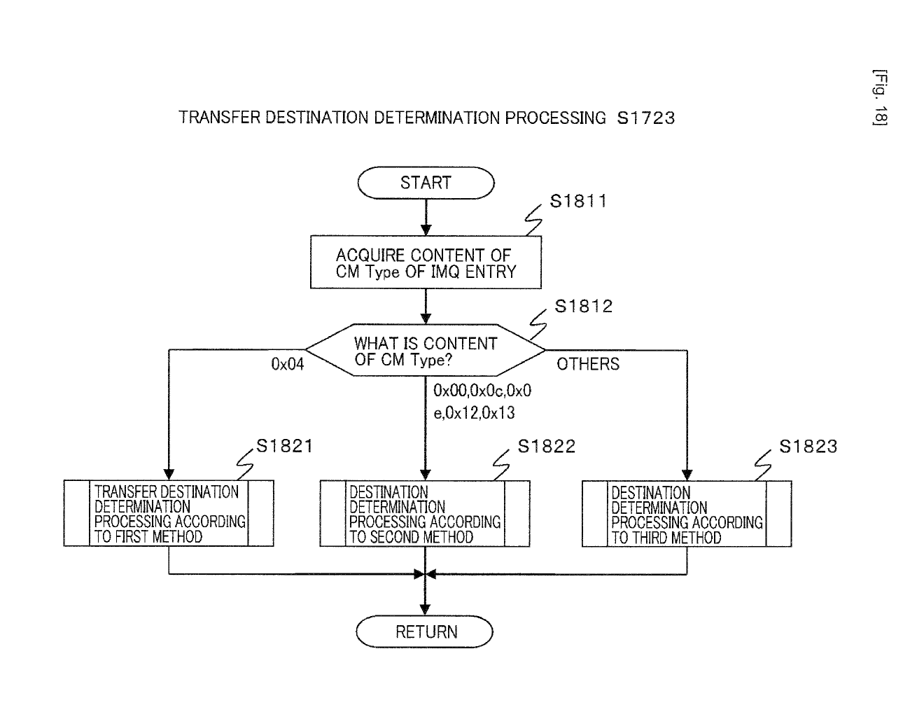

FIG. 17 is a flowchart illustrating processing performed in the channel board 11 of the storage apparatus 10, involving transfer of a received frame to the processor set 1230 (hereinafter referred to as frame transfer processing S1700). With reference to FIG. 17, the frame transfer processing S1700 will be described below.

Upon reception of a frame from the host apparatus 2 (S1711: YES), the frame processing chip 1121 of the channel board 11 registers the frame (IMQ entry 1500 and SFQ entry 1600) in the frame reception queue 1132 (IMQ and SFQ) associated with the port 1151 that has received the frame (S1712).

On the other hand, the frame transfer chip 1122 of the channel board 11 reads the frame (IMQ entry 1500 and SFQ entry 1600) registered in the frame reception queue 1132 as needed (S1721, S1722). On the basis of the content of the read frame, the frame transfer chip 1122 of the channel board 11 determines the processor set 1230 to be the destination of the read frame (S1723), and transfers the frame to the processor set 1230 thus determined (S1724).

FIG. 18 is a flowchart illustrating processing performed at S1723 in FIG. 17 (hereinafter referred to as destination determination processing S1723). With reference to FIG. 18, the destination determination processing S1723 will be described below.

First, the frame transfer chip 1122 acquires a value in the “CM Type” of the IMQ entry 1500 read from the frame reception queue 1132 (S1811). Then, based on the acquired value, the frame transfer chip 1122 determines a method (a first method, a second method, or a third method) for determining a transfer destination (channel processor set 1230) (S1812).

As shown in FIG. 18, when “0x04” is set in the “CM Type” of the IMQ entry 1500 (S1812: 0x04), processing goes to S1821 where the transfer destination is determined by the first method. When “0x0c,” “0x0e,” “0x12,” or “0x13” is set in the “CM Type” of the IMQ entry 1500 (S1812: 0x0c, 0x0e, 0x12, 0x13), processing goes to S1822 where the transfer destination is determined by the second method. When a value other than “0x04”, “0x0c”, “0x0e”, “0x12”, and “0x13” is set in the “CM Type” of the IMQ entry 1500 (S1812: others), processing goes to S1823. After the processing (S1821, S1822, or S1823) is completed, processing goes to S1724 in FIG. 17.

Transfer Destination Determination Processing According to the First Method

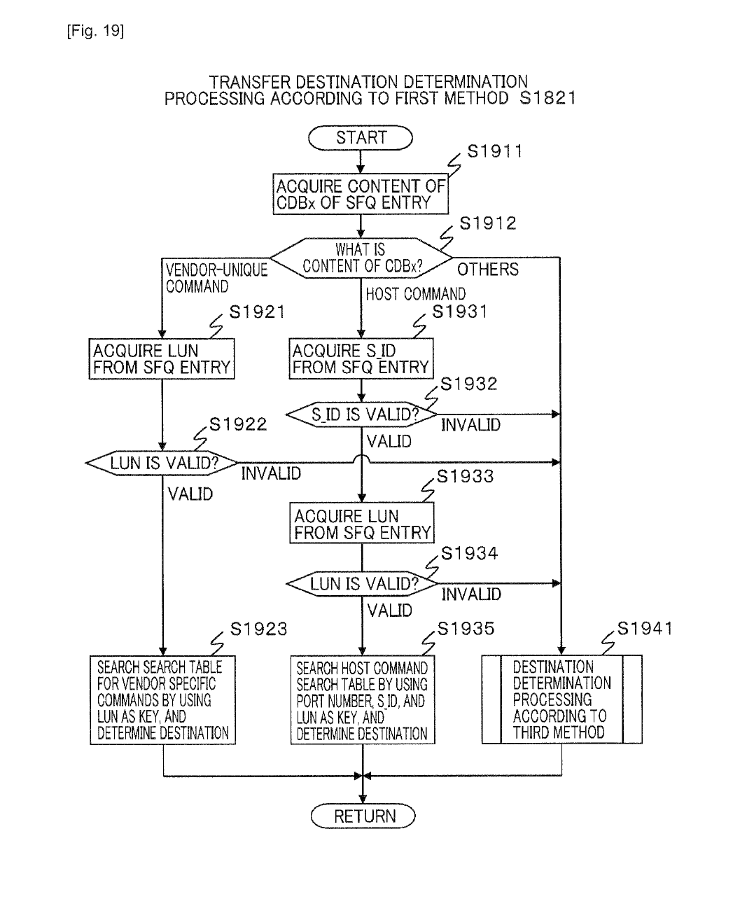

FIG. 19 is a flowchart illustrating processing performed at S1821 in FIG. 18 (hereinafter referred to as destination determination processing S1821 according to the first method). With reference to FIG. 9, the destination determination processing S1821 according to the first method will be described below.

First, the frame transfer chip 1122 acquires a content of the “CDBx” of the SFQ entry 1600 of the frame (S1911), and checks the content of the “CDBx” (S1912).

When a vendor-unique command is set in the “CDBx” of the SFQ entry 1600, processing goes to S1921 (S1912: vendor-unique command). When a host command is set in the “CDBx” of the SFQ entry 1600, processing goes to S1931 (S1912: host command). When a value set in the “CDBx” of the SFQ entry 1600 is neither the vendor-unique command nor the host command (for example, when an invalid code is set) (S1912: others), processing goes to S1941.

At S1912, when a vendor-unique command is set in the “CDBx” of the SFQ entry 1600 (S1912: vendor-unique command), the frame transfer chip 1122 acquires an LUN from the “LUNX” of the SFQ entry 1600 (S1921). Next, the frame transfer chip 1122 judges whether the acquired LUN is valid or invalid (S1922). The LUN is invalid when, for example, an LUN that does not actually exist is set in the “LUNx”. When the LUN is valid (S1922: valid), processing goes to S1923. When the LUN is invalid (S1922: invalid), processing goes to S1941 in order to perform the destination determination processing according to the third method.

At S1923, using the LUN acquired at S1922 as a key, the frame transfer chip 1122 searches the vendor-unique command search table 1212 to determine the processor set 1230 to be the destination for the frame. Subsequently, processing goes to S1714 in FIG. 17.

At S1912, when a host command is set in the “CDBx” of the SFQ entry 1600 (S1912: host command), the frame transfer chip 1122 acquires an S_ID (identifier of a transmitter of the frame) from the “S_ID” of the SFQ entry 1600 (S1931). Next, the frame transfer chip 1122 judges whether the acquired S_ID is valid or invalid (S1932). The S_ID is invalid when, for example, an identifier of the host apparatus 2 that does not actually exist is set in the “S_ID”. When the acquired S_ID is valid (S1932: valid), processing goes to S1933. When the acquired S_ID is invalid (S1922: invalid), processing goes to S1941 in order to perform the destination determination processing according to the third method.

At S1933, the frame transfer chip 1122 acquires the LUN from “LUNx” in the SFQ entry 1600 (S1933). Then, the frame transfer chip 1122 judges whether the acquired LUN is valid or invalid (S1934). The LUN is invalid, when, for example, an LUN that does not actually exist is set in the “LUNx”. When the LUN is valid (S1934: valid), processing goes to S1935. When the LUN is invalid (S1934: invalid), processing goes to S1941 in order to perform the destination determination processing according to the third method.

Next, using the LUN acquired at S1933 as a key, the frame transfer chip 1122 searches the host command search table 1211 to determine the processor set 1230 to be the destination for the frame. Subsequently, processing goes to S1714 in FIG. 17.

At S1912, when a value set in the “CDBx” of the SFQ entry 1600 is neither the vendor-unique command nor the host command (for example, when an invalid code is set) (S1912: others), the frame transfer chip 1122 performs the destination determination processing S1941 according to the third method to determine the destination processor set 1230. The destination determination processing S1941 according to the third method is the same as the destination determination processing S1823 according to the third method of FIG. 18. Subsequently, processing goes to S1714 in FIG. 17.

Destination Determination Processing According to the Second Method

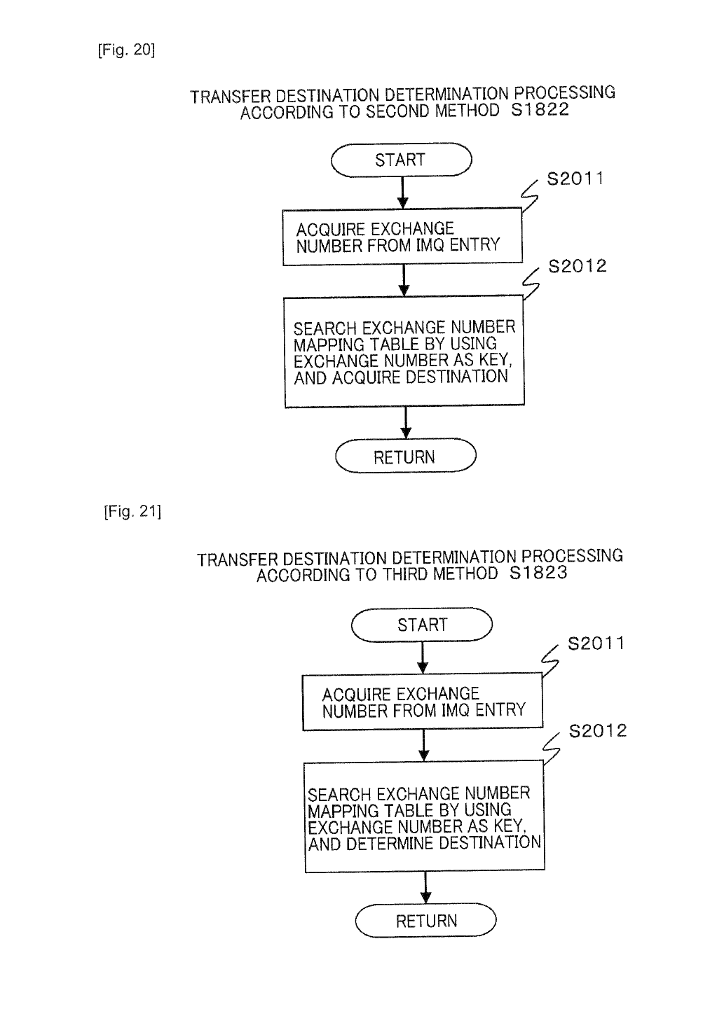

FIG. 20 is a flowchart illustrating processing performed at S1822 in FIG. 18 (hereinafter referred to as destination determination processing S1822 according to the second method). With reference to FIG. 20, the destination determination processing S1822 according to the second method will be described below.

First, the frame transfer chip 1122 acquires an exchange number set in the “SEST_Index” of the IMQ entry 1512 or 1513 (FIG. 15B or FIG. 15C) of the frame (S2011). Next, using the acquired exchange number as a key, the frame transfer chip 1122 searches the exchange number mapping table 1213, and determines the processor set 1230 to be the destination for the frame. Subsequently, processing goes to S1714 of FIG. 17.

Destination Determination Processing According to the Third Method

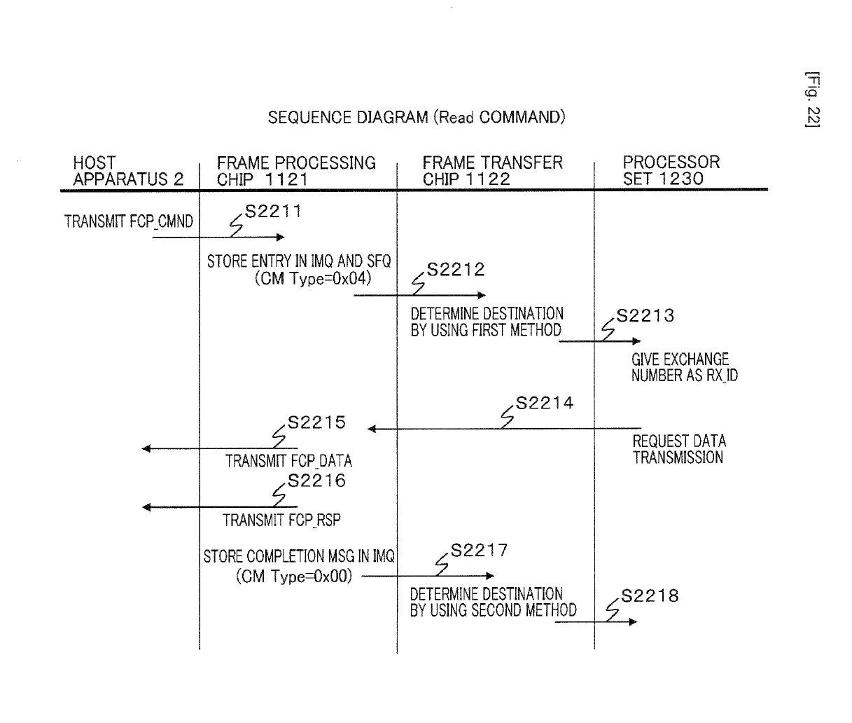

FIG. 21 is a flowchart illustrating processing performed at S1823 in FIG. 18 (hereinafter referred to as destination determination processing S1823 according to the third method). As shown in FIG. 21, using the port number of the port 1151, which has received the frame, as a key, the frame transfer chip 1122 searches the port number mapping table 1214, and determines the processor set 1230 to be the destination for the frame. Subsequently, processing goes to S1714 in FIG. 17.

Next, description will be given on processing performed in the storage apparatus 10 when the frame in which the host command is set is transmitted from the host apparatus 2 to the storage apparatus 10.

Read Processing

FIG. 22 is a diagram illustrating processing performed in the storage apparatus 10 when the storage apparatus 10 receives a frame including a data read request from the host apparatus 2 (a frame in which a “Read” command of the SCSI command is set).

Upon reception of the frame (FCP_CMND) transmitted from the host apparatus 2, the frame processing chip 1121 of the storage apparatus 10 registers the IMQ entry 1500 and the SFQ entry 1600 for the received frame, in the frame reception queue 1132 (S2211).

The frame here is a frame that initiates a new exchange sequence (a frame in which an invalid value (for example, “0xFFFF”) is set in the “RX_ID” of the frame header 1400). Accordingly, the frame processing chip 1121 registers the IMQ entry 1511 shown in FIG. 15A in the frame reception queue 1132. Here, “0x04” is set in the “CM Type”. Consequently, on the basis of determination at S1812 in FIG. 18, the frame transfer chip 1122 performs the destination determination processing S1821 according to the first method to determine the destination processor set 1230.

With respect to the frame registered in the frame reception queue 1132, the frame transfer chip 1122 determines the destination processor set 1230 by the destination determination processing S1821 according to the first method, and transmits the frame to the destination thus determined (S2212, S2213).

Upon reception of the frame, the destination processor set 1230 gives an exchange number to be set in the “RX_ID” of the frame (S2213). When the data specified in the frame is read from the storage device 17, the destination processor set 1230 transmits an instruction to transmit the read data to the host apparatus 2, to the frame processing chip 1121 (S2214).

The frame processing chip 1121 transmits the read data and a read completion report (FCP_DATA, FCP_RSP) to the host apparatus 2 in response to the above-mentioned instruction from the processor set 1230 (S2215, S2216).

Next, in the frame reception queue 1132, the frame processing chip 1121 registers the IMQ entry 1500 and the SFQ entry 1600 for notifying the processor set 1230 of a message (completion MSG) indicating that the read data and the read completion report has been transmitted to the host apparatus 2 (S2217). The frame processing chip 1121 also sets the exchange number of the exchange sequence to which the frame being currently processed belongs, in the “RX_ID” of the SFQ entry 1600.

Here, the frame is not a frame that initiates the exchange sequence. Accordingly, the frame processing chip 1121 registers the IMQ entry 1512 shown in FIG. 15B in the frame reception queue 1132, and sets “0x00” in the “CM Type”. Consequently, on the basis of determination at S1812 in FIG. 18, the frame transfer chip 1122 performs the destination determination processing S1822 according to the second method to determine the destination processor set 1230.

The frame transfer chip 1122 transmits the frame registered in the frame reception queue 1132 to the destination processor set 1230 determined by the destination determination processing S1822 according to the second method. The destination processor set 1230 receives this frame (S2217, S2218). The processing on the received frame is thus completed.

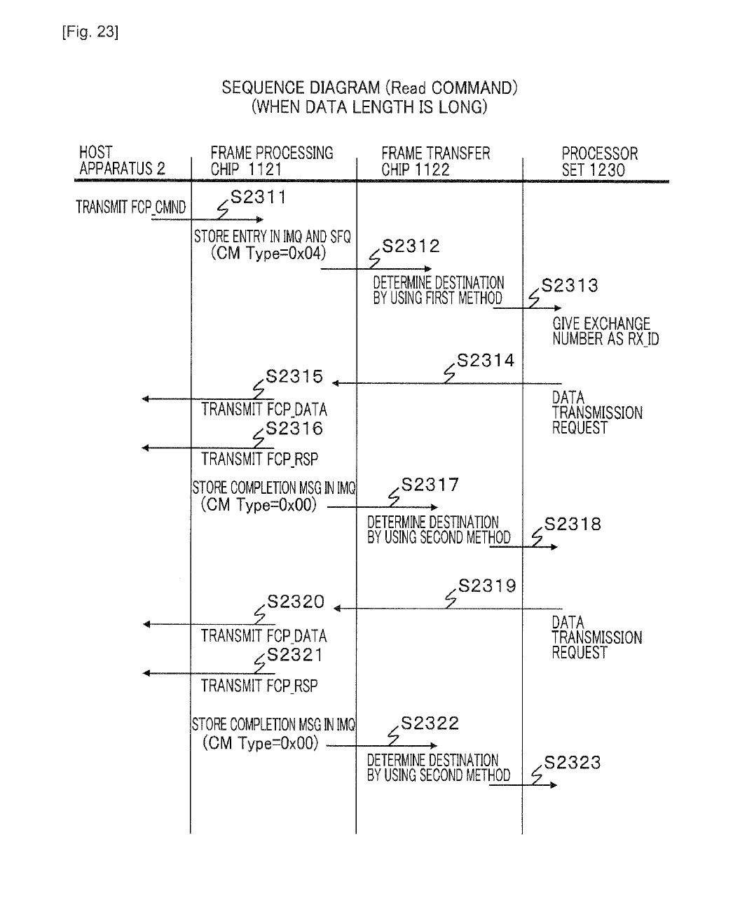

Similarly to FIG. 22, FIG. 23 is a diagram illustrating processing performed in the storage apparatus 10 when the storage apparatus 10 receives a frame including a data read request. However, the processing shown in FIG. 23 is performed when the read data has a data size larger than a predetermined threshold. The above-mentioned threshold is, for example, a limit value (the maximum data length (slot size)) of data to be stored in the cache memory 14.

Processing from S2311 to S2316 shown in FIG. 23 is the same as those from 2211 to S2216 in FIG. 22. However, only part of the read data specified in the data read command (data of a size not more than the above-mentioned maximum data length) is read and transmitted to the host apparatus 2 at S2311 to S2316 in FIG. 23.

At S2317, in the frame reception queue 1132, the frame processing chip 1121 registers the IMQ entry 1500 and the SFQ entry 1600 for notifying the processor set 1230 of a message (completion MSG) indicating that the above-mentioned part of the read data has been transmitted to the host apparatus 2. The frame processing chip 1121 also sets the exchange number of the exchange sequence to which the frame being currently processed belongs, in the “RX_ID” of the SFQ entry 1600.

To the processor set 1230, the frame transfer chip 1122 transfers a frame for reading the remaining read data for the frame corresponding to the above-mentioned message registered in the frame reception queue 1132, and the destination processor set 1230 receives this frame (S2318).

Since the frame registered in the frame reception queue 1132 here is not a frame that initiates the exchange sequence, the frame processing chip 1121 registers the IMQ entry 1512 shown in FIG. 15B in the frame reception queue 1132. Here, “0x00” is set in the “CM Type”. Accordingly, on the basis of determination at S1812 in FIG. 18, the frame transfer chip 1122 performs the destination determination processing S1822 according to the second method to determine the destination processor set 1230.

When the remaining data specified in the frame is read from the storage device 17, the processor set 1230 transmits a request to transmit the read data to the host apparatus 2, to the frame processing chip 1121 (S2319).

The frame processing chip 1121 transmits the read data and a read completion report (FCP_DATA, FC_RSP) to the host apparatus 2 (S2320, S2321).

Next, in the frame reception queue 1132, the frame processing chip 1121 registers the IMQ entry 1500 and SFQ entry 1600 for notifying the processor set 1230 of a message (completion MSG) indicating that the read data and the read completion report has been transmitted to the host apparatus 2 (S2322). The frame processing chip 1121 sets the exchange number of the exchange sequence to which the frame being currently processed belongs, in the “RX_ID” of the SFQ entry 1600.

Since the frame here is not a frame that initiates a new exchange sequence, the frame processing chip 1121 registers the IMQ entry 1512 shown in FIG. 15B in the frame reception queue 1132. Here, “0x00” is set in the “CM Type”. Accordingly, on the basis of determination at S1812 in FIG. 18, the frame transfer chip 1122 performs the destination determination processing S1822 according to the second method to determine the destination processor set 1230.

The frame transfer chip 1122 determines the destination processor set 1230 for the frame registered in the frame reception queue 1132 by the destination determination processing S1822 according to the second method, and transmits the frame to the transfer destination thus determined. The destination processor set 1230 receives the frame thus transmitted (S2322, S2223). The processing on the received frame is thus completed.

Write Processing

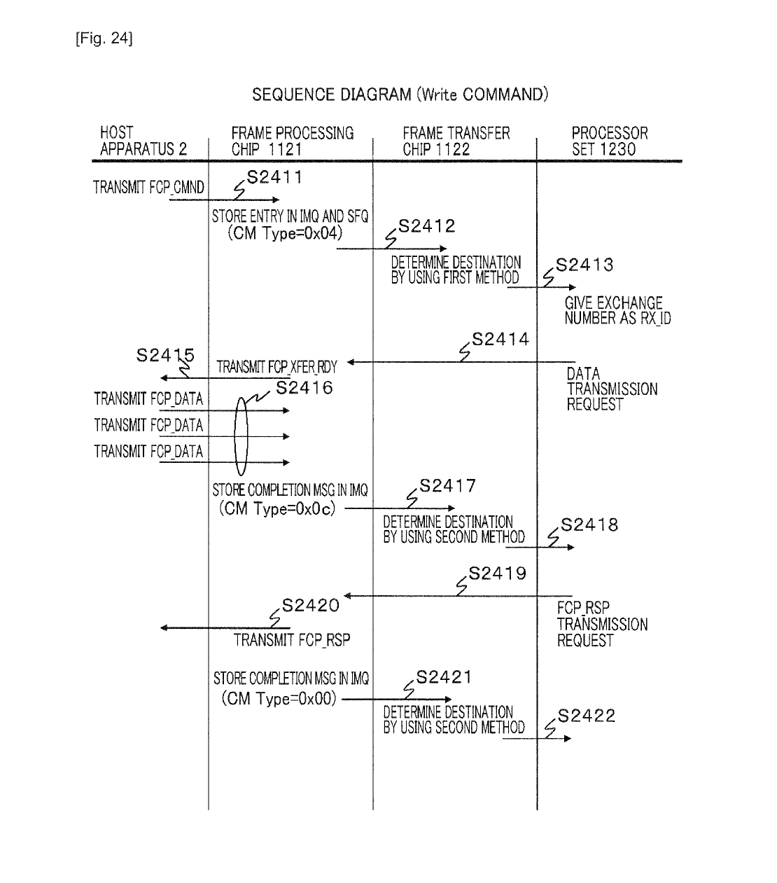

FIG. 24 is a diagram illustrating processing performed in the storage apparatus 10 when the storage apparatus 10 receives a frame including a data write request (for example, a frame in which the SCSI “Write” command is set) from the host apparatus 2.

First, upon reception of the frame (FCP_CMND) transmitted from the host apparatus 2, the frame processing chip 1121 of the storage apparatus 10 registers the IMQ entry 1500 and the SFQ entry 1600 for the received frame, in the frame reception queue 1132 (S2411).

Since the frame here is a frame that initiates a new exchange sequence (the frame in which an invalid value (for example, “0xFFFF”) is set in the “RX_ID” of the frame header 1400), the frame processing chip 1121 registers the IMQ entry 1511 shown in FIG. 15A in the frame reception queue 1132. Here, “0x04” is set in the “CM Type”. Accordingly, on the basis of determination at S1812 of FIG. 18, the frame transfer chip 1122 performs the destination determination processing S1821 according to the first method to determine the processor set 1230 to be the destination.

The frame transfer chip 1122 determines the destination processor set 1230 for the frame registered in the frame reception queue 1132 by the destination determination processing S1821 according to the first method, and transmits the frame to the transfer destination thus determined (S2412, S2413).

Upon reception of the frame, the destination processor set 1230 gives the frame an exchange number to be set in the “RX_ID” (S2413). Subsequently, to the frame processing chip 1121, the destination processor set 1230 transmits an instruction to transmit a request of write data transmission to the host apparatus 2 and an instruction to receive the write data from the host apparatus 2 (S2414).

In response to the above-mentioned instructions from the processor set 1230, the frame processing chip 1121 transmits a request of write data transmission (FCP_XFER_RDY) to the host apparatus 2 (S2415). Then, the frame processing chip 1121 receives the write data (FCP_DATA) transmitted from the host apparatus 2 in response to the request (S2416).

Next, in the frame reception queue 1132, the frame processing chip 1121 registers the IMQ entry 1500 for notifying the processor set 1230 of a message (completion MSG) indicating that the write data (FCP_DATA) has been received (S2417). Moreover, the frame processing chip 1121 sets the exchange number of the exchange sequence to which the frame being currently processed belongs, in the “RX_ID” of the SFQ entry 1600.

Since the frame here is not a frame that initiates the exchange sequence, the frame processing chip 1121 registers the IMQ entry 1513 shown in FIG. 15C in the frame reception queue 1132. Here, “0x0c” is set in the “CM Type”. Accordingly, the frame transfer chip 1122 determines the destination processor set 1230 by the destination determination processing S1822 according to the second method.

The frame transfer chip 1122 transmits the frame registered in the frame reception queue 1132 to the destination processor set 1230 determined by the destination determination processing S1822 according to the second method, and the destination processor set 1230 receives this frame (S2417, S2418).

When writing of the write data into the storage device 17 (or the cache memory 14) is completed, the destination processor set 1230 transmits, to the frame processing chip 1121, an instruction to transmit a write completion report (FCP_RSP) to the host apparatus 2 (S2419).

In response to the above-mentioned instruction, the frame processing chip 1121 transmits the write completion report (FCP_RSP) to the host apparatus 2 (S2420).

Next, in the frame reception queue 1132, the frame processing chip 1121 registers the IMQ entry 1500 for notifying the processor set 1230 of a message (completion MSG) indicating that the write completion report (FCP_RSP) has been transmitted to the host apparatus 2 (S2421).

Since the frame here is not a frame that initiates a new exchange sequence, the frame processing chip 1121 registers the IMQ entry 1512 shown in FIG. 15B in the frame reception queue 1132. Here, “0x00” is set in the “CM Type”. Accordingly, the destination determination processing S1822 according to the second method is performed by the frame transfer chip 1122 to determine the processor set 1230 to be the destination.

The frame transfer chip 1122 determines the destination processor set 1230 by the destination determination processing S1822 according to the second method, and transmits the frame to the transfer destination thus determined. The destination processor set 1230 receives the frame thus transmitted (S2421, S2422). The processing on the received frame is thus completed.

As described so far, when an exchange number can be acquired from the frame received from the host apparatus 2, the storage apparatus 10 according to the present embodiment searches the exchange number mapping table 1213 (third destination search table) for the processor set 1230 associated with the exchange number, and determines the destination processor set 1230 for the frame. Thus, when the exchange number can be acquired from the frame, the destination processor set 1230 can be determined using only the exchange number as a key. Accordingly, the destination can be determined at a higher speed and a lower load. Appropriate load balancing between the processor sets 1230 can be attained by the user appropriately setting the exchange number mapping table 1213 with the management apparatus 3.

Moreover, when the exchange number cannot be acquired, the storage apparatus 10 determines the destination processor set 1230 by searching the host command search table 1211 (first destination search table) with using the port 1151 at which the frame has arrived, the identifier of the host apparatus 2, and the LUN as a key. Accordingly, even when the exchange number cannot be acquired from the frame, appropriate load balancing among the processors can be attained when the frame includes a host command. Appropriate load balancing between the processor sets 1230 can be attained by the user appropriately setting the host command search table 1211 with the management apparatus 3.

Moreover, when the exchange number cannot be acquired, the storage apparatus 10 determines the destination processor set 1230 by searching the vendor-unique command search table 1212 with using the LUN included in the frame as a key. Accordingly, even when the exchange number cannot be acquired from the frame, load balancing among the processors can be attained. Furthermore, since the destination processor set 1230 can be determined using only the identifier of the logical volume as a key, the destination processor set 1230 can be determined at a higher speed and a lower load. Appropriate load balancing between the processor sets 1230 can be attained by the user appropriately setting the vendor-unique command search table 1212 with the management apparatus 3.

Moreover, when the destination processor set 1230 cannot be determined by any of the above-mentioned methods, the storage apparatus 10 determines the destination processor set 1230 by searching the port number mapping table 1214 (fourth destination search table) with using the port 1151 at which the frame has arrived as a key. Accordingly, even when the destination processor set 1230 cannot be determined by any of the above-mentioned methods, load balancing between the processor sets 1230 can be attained. Furthermore, since the destination processor set 1230 can be determined using only the port 1151 as a key, the destination processor set 1230 can be determined at a higher speed and a lower load. Appropriate load balancing between the processor sets 1230 can be attained by the user appropriately setting the port number mapping table 1214 with the management apparatus 3.

Furthermore, to notify the processor set 1230 of a message (completion report) indicating that the host apparatus 2 has received a response regarding to the processing on the data I/O request, the storage apparatus 10 registers, in the frame reception queue 1132, the frame including the exchange number of the exchange sequence to which the frame being currently processed (the frame concerning the message) belongs. Then, the storage apparatus 10 determines the destination of the registered frame by acquiring the processor set 1230 associated with the exchange number set in the frame from the exchange number mapping table 1213 (third destination search table). Thus, according to the storage apparatus 10 of the present embodiment, even when internal communication is performed between the frame processing chip 1121 and the processor set 1230, the destination processor set 1230 is appropriately selected. Accordingly, more secure load balancing between the processor sets 1230 can be attained.

While the present embodiment has been described above, the above-mentioned embodiment is intended for facilitating understanding of the present invention, and is not intended for limiting interpretation of the present invention. The present invention may be modified and improved without deviating from the spirit thereof, and equivalents thereof are also included in the present invention.

1. A storage apparatus comprising:
at least one channel board for receiving a data frame transmitted from an external apparatus, the data frame including a data I/O request;
at least one drive board for writing data into a storage device and reading data from the storage device, the storage device being formed of a plurality of storage drives;
a cache memory for storing any of write data to be written into the storage device and read data having read from the storage device;
a plurality of processor boards each for performing data transfer between at least two of the channel board, the drive board, and the cache memory; and
a shared memory accessible by the processor boards, wherein the channel board
stores a third destination search table that associates a sequence identifier with a processor identifier, the sequence identifier being information that identifies a sequence of a series of data frames delivered to and received from the external apparatus and to which the data frame belongs, the processor identifier being information that identifies a processor included in the processor board,
determines the processor to be a destination for the received data frame, by acquiring, from the third destination search table, the processor identifier associated with the sequence identifier acquired from the received data frame, and
transfers the received data frame to the processor thus determined, and the processor that has received the data frame performs processing with regard to the data frame.

2. A storage apparatus comprising:
at least one channel board for receiving a data frame transmitted from an external apparatus, the data frame including a data I/O request;
at least one drive board for writing data into a storage device and reading data from the storage device, the storage device being formed of a plurality of storage drives;
a cache memory for storing any of write data to be written into the storage device and read data having read from the storage device;
a plurality of processor boards each for performing data transfer between at least two of the channel board, the drive board, and the cache memory; and
a shared memory accessible by the processor boards, wherein the channel board
stores a third destination search table that associates a sequence identifier with a processor identifier, the sequence identifier being information that identifies a sequence of a series of data frames delivered to and received from the external apparatus and to which the data frame belongs, the processor identifier being information that identifies a processor included in the processor board, and
determines the processor to be a destination for the received data frame, by acquiring, from the third destination search table, the processor identifier associated with the sequence identifier acquired from the received data frame,
the channel board stores a first destination search table that associates an identifier of a communication port included in the channel board, an identifier of the external apparatus, an identifier of a logical volume provided by the storage device, and the processor identifier with each other,
when the sequence identifier cannot be acquired from the received data frame, the channel board determines the processor to be the destination for the data frame by acquiring, from the first destination search table, the processor identifier associated with a combination of the identifier of the communication port at which the data frame has arrived, the identifier of the external apparatus included in the data frame, and the identifier of the logical volume included in the data frame,
the channel board stores a second destination search table that associates the identifier of the logical volume provided by the storage device with the processor identifier,
when the sequence identifier cannot be acquired from the received data frame, the channel board determines the processor to be the destination for the data frame by acquiring, from the second destination search table, the processor identifier associated with the identifier of the logical volume included in the data frame,
the channel board stores a fourth destination search table that associates the identifier of the communication port with the processor identifier, when the processor to be the destination for the data frame cannot be determined using any of the first to the third destination search tables, the channel board determines the processor to be the destination for the received data frame by acquiring, from the fourth destination search table, the processor identifier associated with the identifier of the communication port at which the data frame has arrived, and transfers the received data frame to the processor thus determined, and
the processor that has received the data frame performs processing with regard to the data frame.

3. The storage apparatus according to claim 1, wherein
the channel board stores a first destination search table that associates an identifier of a communication port included in the channel board, an identifier of the external apparatus, an identifier of a logical volume provided by the storage device, and the processor identifier with each other,
when the sequence identifier cannot be acquired from the received data frame, the channel board determines the processor to be the destination for the data frame by acquiring, from the first destination search table, the processor identifier associated with a combination of the identifier of the communication port at which the data frame has arrived, the identifier of the external apparatus included in the data frame, and the identifier of the logical volume included in the data frame, and transfers the received data frame to the processor thus determined, and
the processor that has received the data frame performs processing with regard to the data frame.

4. The storage apparatus according to claim 1, wherein
the channel board stores a second destination search table that associates the identifier of the logical volume provided by the storage device with the processor identifier,
when the sequence identifier cannot be acquired from the received data frame, the channel board determines the processor to be the destination for the data frame by acquiring, from the second destination search table, the processor identifier associated with the identifier of the logical volume included in the data frame, and transfers the received data frame to the processor thus determined, and
the processor that has received the data frame performs processing with regard to the data frame.

5. The storage apparatus according to claim 1, wherein the channel board comprises:
a frame processing chip that registers the data frame received from the external apparatus in a queue; and
a frame transfer chip that reads the data frame from the queue, determines a processor to be the destination for the read data frame, and transfers the data frame to the processor thus determined.

6. The storage apparatus according to claim 5, wherein
the frame processing chip registers the data frame including the sequence identifier in the queue, the data frame being for notifying the processor of a message indicating that the external apparatus has been responded with regard to the processing performed according to the data I/O request, and
the frame transfer chip determines the processor to be the destination for the data frame by acquiring, from the third destination search table, the processor identifier associated with the sequence identifier acquired from the data frame, and transfers the received data frame to the processor thus determined to be the destination.

7. The storage apparatus according to claim 1, wherein
the data frame is an FC frame of Fibre Channel protocol,
the sequence is an exchange sequence, and
the sequence identifier is an exchange number set in an RX_ID of the FC frame.

8. The storage apparatus according to claim 1, wherein the processor identifier is an identifier that identifies a processor set formed of a plurality of the processors.

9. A method for controlling a storage apparatus, the storage apparatus including
at least one channel board for receiving a data frame transmitted from an external apparatus, the data frame including a data I/O request;
at least one drive board for writing data into a storage device and reading data from the storage device, the storage device being formed of a plurality of storage drives;
a cache memory for storing any of write data to be written into the storage device and read data having read from the storage device;
a plurality of processor boards each for performing data transfer between at least two of the channel board, the drive board, and the cache memory; and
a shared memory accessible by the processor boards, the method comprising:
the channel board
storing a third destination search table that associates a sequence identifier with a processor identifier, the sequence identifier being information that identifies a sequence of a series of data frames delivered to and received from the external apparatus and to which the data frame belongs, the processor identifier being information that identifies a processor included in the processor board, and
determining the processor to be a destination for the received data frame, by acquiring, from the third destination search table, the processor identifier associated with the sequence identifier acquired from the received data frame,
the channel board storing a first destination search table that associates an identifier of a communication port included in the channel board, an identifier of the external apparatus, an identifier of a logical volume provided by the storage device, and the processor identifier with each other,
when the sequence identifier cannot be acquired from the received data frame, the channel board determining the processor to be the destination for the data frame by acquiring, from the first destination search table, the processor identifier associated with a combination of the identifier of the communication port at which the data frame has arrived, the identifier of the external apparatus included in the data frame, and the identifier of the logical volume included in the data frame,
the channel board storing a second destination search table that associates the identifier of the logical volume provided by the storage device with the processor identifier,
when the sequence identifier cannot be acquired from the received data frame, the channel board determining the processor to be the destination for the data frame by acquiring, from the second destination search table, the processor identifier associated with the identifier of the logical volume included in the data frame,
the channel board storing a fourth destination search table that associates the identifier of the communication port with the processor identifier,
when the processor to be the destination for the data frame cannot be determined using any of the first to the third destination search tables, the channel board determining the processor to be the destination for the received data frame by acquiring, from the fourth destination search table, the processor identifier associated with the identifier of the communication port at which the data frame has arrived, and transferring the received data frame to the processor thus determined, and
the processor that has received the data frame performing processing with regard to the data frame.
